(19) United States
(12) Patent Application Publication
(10) Pub. No.: US 2006/0178924 A1
(43) Pub. Date: Aug. 10, 2006

(54) Information processing system, image processing system, execution control apparatus, execution control method, and computer product

(76) Inventor: Yutaka Yagiura, Tokyo (JP)

Correspondence Address: HARNESS, DICKEY & PIERCE, P.L.C., P.O. BOX 8910, RESTON, VA, 20195, US

(21) Appl. No.: 11/325,342

(22) Filed: Jan. 5, 2006

(30) Foreign Application Priority Data
Jan. 14, 2005 (JP) 2005-008410

(51) Int. Cl. G05B 19/418

(52) U.S. Cl. 705/8

(57) ABSTRACT

A network-information managing unit manages first information on a device included in an information processing apparatus that is connected to a network. A device-information acquiring unit acquires, when setting an execution device that executes a service of a workflow in which the service is defined, second information on a device that matches a setting condition from the network-information managing unit. An execution-device setting unit sets the execution device in the workflow based on the second information.

### CROSS-REFERENCE TO RELATED APPLICATIONS

The present document incorporates by reference the entire contents of Japanese priority document, 2005-008410 filed in Japan on Jan. 14, 2005.

### BACKGROUND OF THE INVENTION

1. Field of the Invention

The present invention relates to an information processing system, an image processing system, an execution control apparatus, an execution control method, and a computer product for outputting image data by, for example, printing with a printer, a facsimile (FAX) transmission, and a file attached to an e-mail.

2. Description of the Related Art

In a conventional image output system, apparatuses capable of executing at least one of a reading an image, a printing an image, a FAX transmission of an image, and a transmission of image data via an e-mail are connected via a network.

With the recent enhancement of the performances and multi-functions of individual devices, sometimes a plurality of devices is capable of executing the same services within an area, such as an office room, where such an image output system can be easily used via a network.

A conventional technology designed to allow an image forming system to do scheduling in consideration of an efficient work order is described in Japanese Patent Application Laid-open No. 2004-310746. According to the conventional technology, the image forming system has a scheduling unit that schedules a plurality of steps for a print job to be done by the system.

According to the conventional image output system, a plurality of devices capable of executing the same services often have different specifications due to a difference between a color printing and a monochrome printing, a difference in a range of printing quality that can be set, presence or absence of a double-side printing capability, a difference in printing speed, and a difference in printing cost.

When there is a plurality of multi-function apparatuses capable of executing multiple services, such as multifunction peripherals (MFPs), within an area, such as an office room, where an image output system is easily used via a network, a user needs to know the function characteristics of available devices connected to the network, and the features of the specifications of the devices one by one, to create a workflow combining execution devices that match services desired by the user or the user's conditions. This takes time to efficiently use the devices.

While the conventional technology is suitable in making processes efficient in a print industry and a print on demand (POD) market, it is not designed to take into account how to make individual devices easier to use under the circumstances where a plurality of devices of different specifications that can execute the same services is present within a usable area, such as an office room.

### SUMMARY OF THE INVENTION

It is an object of the present invention to at least solve the problems in the conventional technology.

An information processing system according to one aspect of the present invention includes a network-information managing unit that manages first information on a device included in an information processing apparatus that is connected to a network; a device-information acquiring unit that acquires, when setting an execution device that executes a service of a workflow in which the service is defined, second information on a device that matches a setting condition from the network-information managing unit; and an execution-device setting unit that sets the execution device in the workflow based on the second information.

An image processing system according to another aspect of the present invention includes a network-information managing unit that manages first information on a device included in an image processing apparatus that is connected to a network; a device-information acquiring unit that acquires, when setting an execution device that executes a service of a workflow in which the service is defined, second information on a device that matches a setting condition from the network-information managing unit; and an execution-device setting unit that sets the execution device in the workflow based on the second information.

An execution control apparatus according to still another aspect of the present invention includes a device-information acquiring unit that acquires, when setting an execution device that executes a service of a workflow in which the service is defined, information on a device that matches a setting condition, from among a plurality of devices included in an image processing apparatus that is connected to a network; and an execution-device setting unit that. sets the execution device in the workflow based on the information.

An information processing system according to still another aspect of the present invention includes a service acquiring unit that acquires a service provided by a device included in an information processing apparatus that is connected to a network; a service display unit that displays the service in a form of a symbol; and a workflow creating unit that creates a workflow by selecting the symbol and arranging the selected symbol on a screen.

An execution control method according to still another aspect of the present invention includes managing first information on a device included in an information processing apparatus that is connected to a network; acquiring, when setting an execution device that executes a service of a wbrkflow in which the service is defined, second information on a device that matches a setting condition; and setting the execution device in the workflow based on the second information.

An execution control method according to still another aspect of the present invention includes managing first information on a device included in an image processing apparatus that is connected to a network; acquiring, when setting an execution device that executes a service of a workflow in which the service is defined, second information on a device that matches a setting condition; and setting the execution device in the workflow based on the second information.

An execution control method according to still another aspect of the present invention includes acquiring, when setting an execution device that executes a service of a workflow in which the service is defined, information on a device that matches a setting condition, from among a plurality of devices included in an image processing apparatus that is connected to a network; and setting the execution device in the workflow based on the information.

A computer-readable recording medium according to still another aspect of the present invention stores a computer program for causing a computer to execute managing first information on a device included in an information processing apparatus that is connected to a network; acquiring, when setting an execution device that executes a service of a workflow in which the service is defined, second information on a device that matches a setting condition; and setting the execution device in the workflow based on the second information.

A computer-readable recording medium according to still another aspect of the present invention stores a computer program for causing a computer to execute managing first information on a device included in an image processing apparatus that is connected to a network; acquiring, when setting an execution device that executes a service of a workflow in which the service is defined, second information on a device that matches a setting condition; and setting the execution device in the workflow based on the second information.

A computer-readable recording medium according to still another aspect of the present invention stores a computer program for causing a computer to execute acquiring, when setting an execution device that executes a service of a workflow in which the service is defined, information on a device that matches a setting condition, from among a plurality of devices included in an image processing apparatus that is connected to a network; and setting the execution device in the workflow based on the information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image output system according to a first embodiment of the present invention;

FIG. 2 is a block diagram of a client personal computer (PC) used in the image output system according to the first embodiment;

FIG. 3 is a block diagram of a server used in the image output system according to the first embodiment;

FIG. 4 is a block diagram of a discovery used in the image output system according to the first embodiment;

FIG. 5 is a sequence diagram of an operational example when an execution device is designated in the image output system according to the first embodiment;

FIG. 6 is a schematic for illustrating an example of a workflow creating screen;

FIGS. 7A to 7E are schematics for illustrating display examples of connection restrictions on the workflow creating screen;

FIG. 8 is a schematic for illustrating an example of an execution result screen;

FIG. 9 is a schematic for illustrating an example of symbols representing results on the execution result screen;

FIG. 10 is a schematic for illustrating an example of an execution result screen for a device that has failed in executing a service;

FIG. 11 is a sequence diagram of an operational example when an execution device in the image output system according to the first embodiment is automatically selected;

FIG. 12 is a block diagram of an image output system according to a second embodiment of the present invention;

FIG. 13 is a block diagram of a server used in the image output system according to the second embodiment;

FIG. 14 is a sequence diagram of an operational example when an execution device is designated in the image output system according to the second embodiment;

FIG. 15 is a sequence diagram of an operational example when an execution device in the image output system according to the second embodiment is automatically selected;

FIG. 16 is a block diagram of an image output system according to a third embodiment of the present invention;

FIG. 17 is a block diagram of a server used in the image output system according to the third embodiment;

FIG. 18 is a sequence diagram of an operational example when the execution device is designated in the image. output system according to the third embodiment;

FIG. 19 is a sequence diagram of an operational example when the execution device in the image output system according to the third embodiment is automatically selected;

FIG. 20 is a block diagram of an image output system according to a fourth embodiment of the present invention;

FIG. 21 is a block diagram of a server used in the image output system according to the fourth embodiment;

FIG. 22 is a sequence diagram of an operational example when the execution device is designated in the image output system according to the fourth embodiment; and

FIG. 23 is a sequence diagram of an operational example when the execution device in the image output system according to the fourth embodiment is automatically selected.

### DETAILED DESCRIPTION OF THE PREFERRED EMBODIMENTS

Exemplary embodiments of the present invention are explained below in detail with reference to the accompanying drawings.

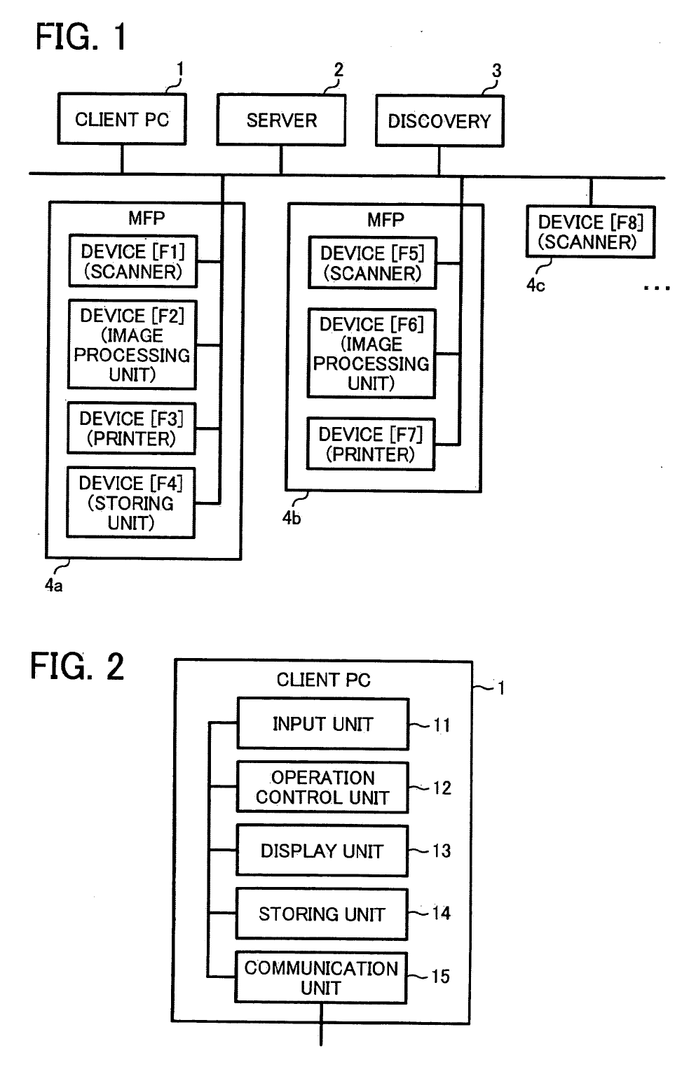

FIG. 1 is a block diagram of an image output system according to a first embodiment of the present invention. The image output system includes a client PC 1, a server (execution control apparatus) 2, a discovery 3, and devices having functions to execute services, all connected to one another via a network.

In the example shown in FIG. 1, an MFP 4a includes devices [F1] to [F4] each connected to the network, an MFP 4b has devices [F5] to [F7] each connected to the network, and a scanner 4c as a device [F8] connected to the network.

FIG. 2 is a block diagram of the client PC 1 used in the image output system according to the first embodiment. The client PC 1 includes an input unit 11 that receives an input from a user, an operation control unit 12 that controls the entire operation of the client PC 1, such as an input of operation, a display unit 13, a storing unit 14, and a communication unit 15 that communicates with apparatuses via the network. The client PC 1 is used by the user to operate the server 2 to perform the input of operation thereto.

The operation control unit 12 is realized by installing a setting application for making various kinds of setting to the server 2 beforehand.

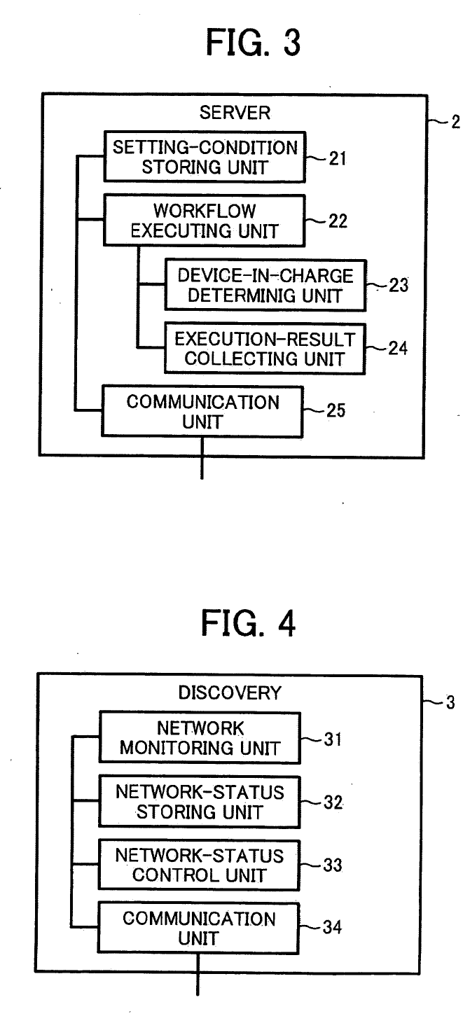

FIG. 3 is a block diagram of the server 2 used in the image output system according to the first embodiment. The server 2 includes a setting-condition storing unit 21 that stores setting conditions set by the user, a workflow executing unit 22 that performs an execution control for executing a workflow based on the set setting conditions, a device-in-charge determining unit (device-information acquiring unit and execution-device determining unit) 23 that automatically determines a device in charge of executing a service in the workflow, an execution-result collecting unit 24, and a communication unit 25 that communicates with apparatuses via the network.

FIG. 4 is a block diagram of the discovery 3 used in the image output system according to the first embodiment. The discovery 3 includes a network monitoring unit 31 that monitors the present status of each device connected to the network, a network-status storing unit 32 that stores the present status of each device acquired by the network monitoring unit 31, a network-status control unit 33 that controls the entire operation of the discovery 3, such as management of the present status of the network, and a communication unit 34 that communicates with apparatuses via the network.

Accordingly, the network monitoring unit 31, the network-status storing unit 32, and the network-status control unit 33 work as a network-information managing unit that manages execution device on available devices connected to the network.

The MFPs 4a, 4b include devices corresponding to individual services, such as a scanner, an image processing unit, and a printer. The MFPs 4a, 4b are constructed in a way such as to be able to operate the devices alone based on an operational input made by the user, as well as to operate any one of the devices via the network in response to a command signal received from the server 2 via the network.

The devices that are connected to the network can be the single device [F8] like the scanner 4c shown in FIG. 1, for example, as long as the device can operate under the control of the server 2 via the network.

As the image output system according to the first embodiment is constructed as mentioned above, devices including those which can execute the same. service are connected together via the network, and each device in the device group can be allowed to execute each service as a workflow based on the setting conditions set through the client PC 1 by the user.

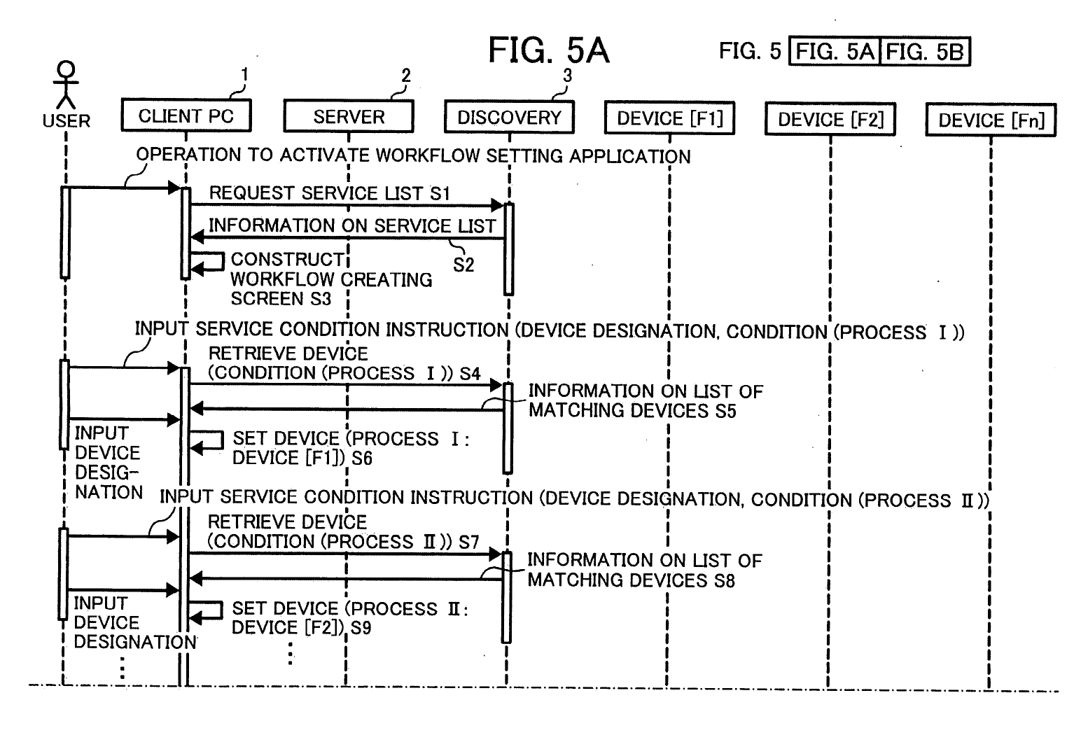

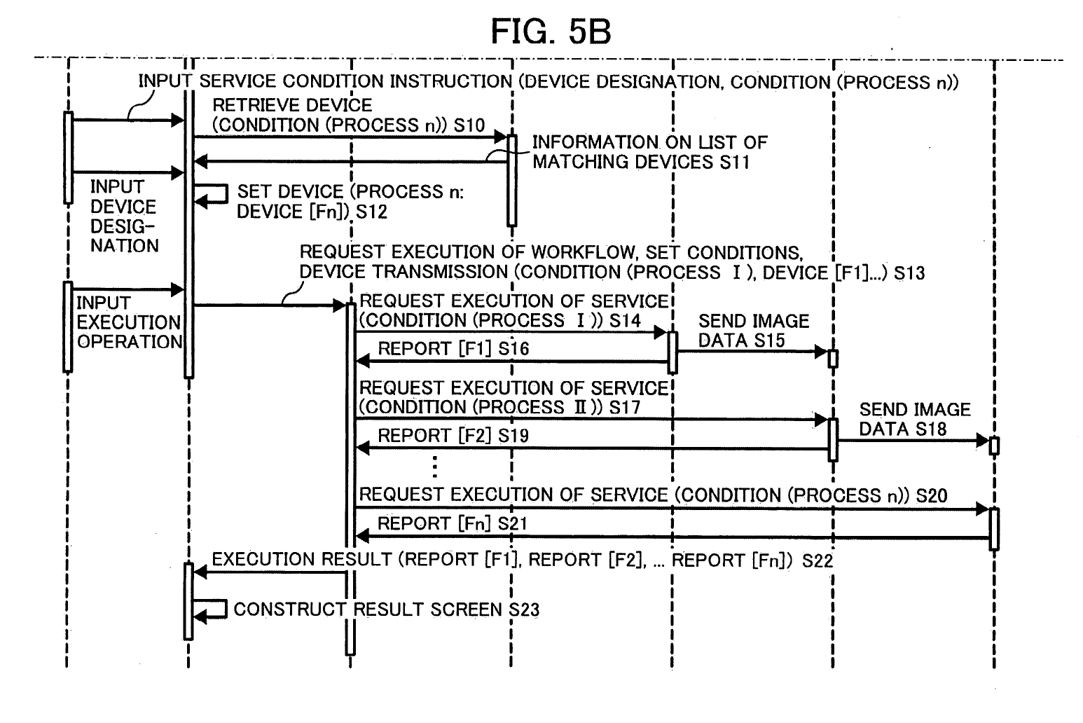

FIG. 5 is a sequence diagram of an operational example when an execution device is designated in the image output system according to the first embodiment.

When the user operates the input unit 11 of the client PC 1 to activate a workflow setting application, the operation control unit 12 of the client PC 1 requests the discovery 3 of a list of available services by the communication unit 15 (step S1).

Upon reception of the request of the service list, the network-status control unit 33 of the discovery 3 refers to the network-status storing unit 32 to create information on a list of executable services from information on available devices in the image output system at this point of time, and sends the information on the service list to the client PC 1 (step S2).

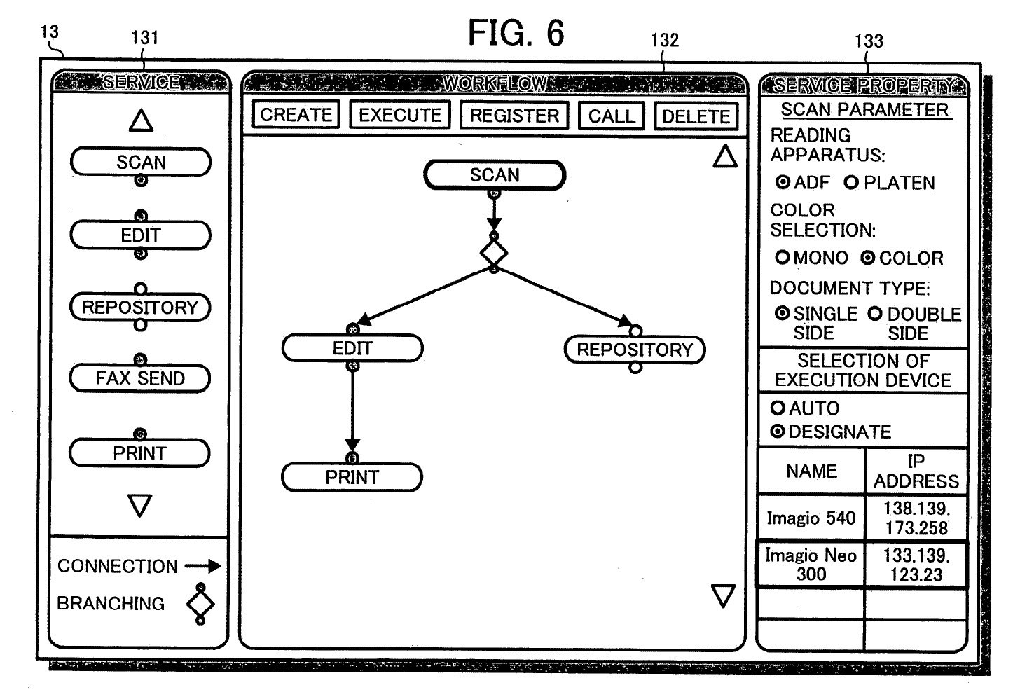

Upon reception of the information on the service list, the operation control unit 12 of the client PC 1 constructs a workflow creating screen (operation screen) as shown in, for example, FIG. 6, displays the screen on the display unit 13, and creates a workflow (step S3).

FIG. 6 is a schematic for illustrating an example of the workflow creating screen displayed on the display unit 13. On the workflow creating screen, a service selector 131 for selecting a service, a workflow display unit 132, which is a main screen to display a set workflow or the like, and a service property 133 for selecting a function detail (parameter) and an execution device in each service are displayed on the display unit 13.

The service selector. 131 displays a list of selectable services, which is sent from the discovery 3. Specifically, services provided by individual devices present on the network, such as “Scan” (image reading), “Edit” (image processing), “Repository” (storing unit), “FAXSend” (FAX transmission), and “Print” (image printing). This can allow the user to check and select available services without being conscious about what services are provided by which devices on the network.

The service selector 131 displays connection symbols indicating the connection of services and the flow of data and a branch symbol indicating a branching of a data flow. As a combination of the symbols indicating the individual services and the connection and branching symbols is pasted to the workflow display unit 132, a workflow can be easily created.

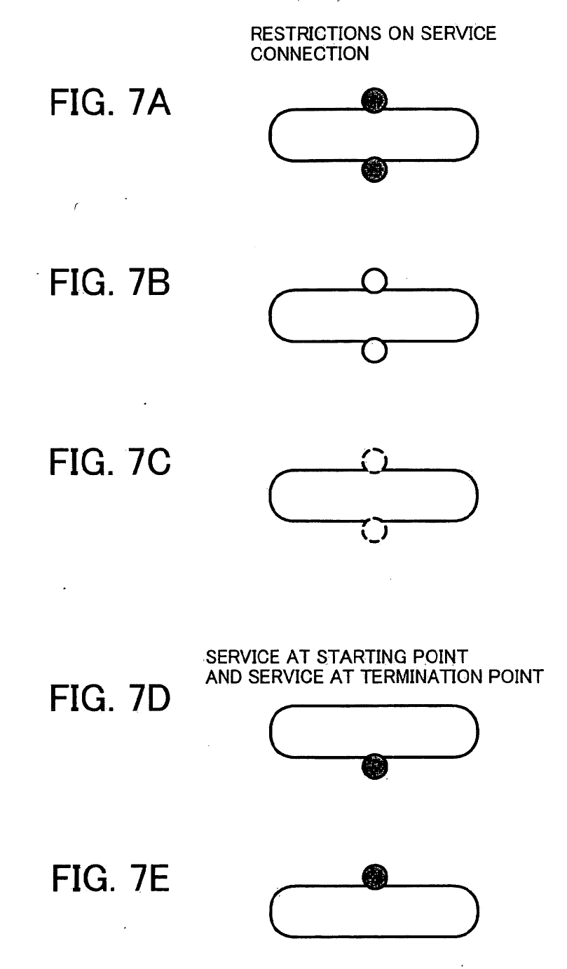

The symbols indicating the individual services to be displayed on the service selector 131 are displayed based on symbols indicating connection restrictions. FIGS. 7A to 7E are schematics for illustrating display examples of the connection restrictions on the workflow creating screen.

An example shown in FIG. 7A represents a connection restriction when it is essential to connect an input source to a service and connect the service to an output destination. That is, when connection of the input source to the service is essential, a black circle is drawn above a character portion, and when connection of the service to the output destination is essential, a black circle is drawn below the character portion. For example, the “Edit” service performs various processes on input image data, and outputs processed image data to another service, and requires connection to the input source and to the output destination. Therefore, the “Edit” service is represented by a symbol with black circles drawn above and below the character portion “Edit”.

An example shown in FIG. 7B represents a connection restriction when connection to a service is optional. That is, when connection of the input source to the service is optional, a white circle is drawn above the character portion, and when connection of the service to the output destination is essential, a white circle is drawn below the character portion. For example, the “Repository” service can store input image data in a storing unit, or can read stored image data from the storing unit, and connection to another service is optional. Therefore, the “Repository” service is represented by a symbol with white circles drawn above and below the character portion “Repository”.

An example shown in FIG. 7C represents a connection restriction when connection to a service is not possible. That is, when connection of the input source to the service is not possible, a dotted circle which means that there is no symbol is drawn above the character portion, and no symbol is drawn. When connection of the service to the output destination is not possible, there is no symbol drawn below the character portion.

An example shown in FIG. 7D represents that a service can be used only as a start point of a workflow, with a black circle drawn below the character portion. For example, the “Scan” service scans a document by a scanner, outputs scanned image data to another service, and requires no image data to be input from another service of the system, but requires connection to the output destination. Therefore, the “Scan” service is represented by a symbol with a black circle drawn below the character portion “Scan”.

An example shown in FIG. 7E represents that a service can be used only as a termination point of a workflow, with a black circle drawn above the character portion. For example, the “Print” service prints out input image data, and thus requires connection to the input source. The workflow is completed as image data input from another service is printed out. In other words, the “Print” service is the termination point of the workflow, and is represented by a symbol with a black circle drawn above the character portion “Print”.

Such connection restrictions are included in service list information acquired from the discovery 3 at the step S2. Based on the service list information, the operation control unit 12 of the client PC 1 creates the display of individual services including the connection restrictions display represented by symbols shown in FIGS. 7A to 7E, and displays the services on the service selector 131.

The workflow display unit 132 has functions of Create, Execute, Register, Call, and Delete. The Create on the workflow display unit 132 is a function of creating a new workflow by selecting individual services displayed on the service selector 131, laying out the symbols of the selected services, and connecting between the services.

The Execute on the workflow display unit 132 is a function of executing a newly created workflow or a called workflow by a device set in the workflow. The Register is a function of registering a new workflow or a changed workflow. The Call is a function of reading a registered workflow and displaying the workflow on the workflow display unit 132. The Delete is a function of deleting a registered workflow.

When the user newly sets a workflow, a workflow for executing intended processes can be easily created by combining plural services through simple operations, such as selecting the Create on the workflow display unit 132, pasting target services displayed on the service selector 131 on the workflow display unit 132 by click and drag, and connecting the services by connection arrows or the branch symbol according to the connection restrictions.

A workflow of sending image data read by the “Scan” service to the “Edit” service and the “Repository” service, and printing out image data processed by the “Edit” service by the “Print” service is set in the example of the workflow display unit 132 shown in FIG. 6.

The service property 133 includes a parameter selection screen and an execution-device selection screen. The parameter selection screen shows parameters, which can be set service by service, for the respective services displayed on the workflow display unit 132. The execution-device selection screen displays a list of device that can execute selected functions by inquiring the discovery 3 of those devices that have the function of the parameter selected on the parameter selection screen. When “Designate” is set on the execution-device selection screen, all the devices that have the function are displayed, and indication of an execution device from the devices is accepted. When “Auto” is set, one device is automatically selected based on a predetermined priority order. The details of the setting of “Auto” will be given later.

The user selects one service from the services constituting the workflow displayed on the workflow display unit 132. The service property 133 displays parameters for the selected service on the parameter selection screen. The user sets a parameter on the parameter selection screen of the service property 133. The client PC 1 inquires the discovery 3 of a device that matches the condition of the set parameter (step S4).

In the present example, the “Scan” service, which is one of the services constituting the workflow displayed on the workflow display unit 132, is selected. The selection of the “Scan” service makes the service property 133 to display the parameter selection screen corresponding to the selected “Scan” service. When the user sets the function of the parameter, the client PC 1 inquires the discovery 3 of a device having the function of the selected parameter. Specifically, the client PC 1 inquires the discovery 3 of a device capable of executing the “Scan” service having “ADF” as a “reading apparatus”, “color” as “color selection”, and “single side” as an “document type” as “Scan” parameters. The discovery 3 can be inquired of a matching device after all the parameters are set or every time each parameter is set.

Upon reception of the retrieval request for a device matching the condition, the network-status control unit 33 of the discovery 3 refers to the network-status storing unit 32 to create information on a list of matching devices from information on available devices in the image output system at this point of time, and sends the information on the matching device list to the client PC 1 (step S5).

Upon reception of the list of matching devices, the client PC 1 displays the list of matching devices on the execution-device selection screen of the service property 133. When the user designates any device from the displayed list of devices, the client PC 1 sets the designated device as an execution device in the selected service (step S6).

The execution-device selection screen of the service property 133 displays a list of information on “Imagio 540” and “ImagioNeo 300”, which are matching devices, for example, the names of the devices and the IP addresses thereof, as the result of the inquiry. As the user selects “ImagioNeo 300” from the execution-device selection screen, “ImagioNeo 300” is set as a device that executes the “Scan” service in the workflow. Accordingly, the execution device can be selected from the list of devices matching the parameters selected on the parameter selection screen, making it possible to easily set devices having the functions desired by the user in the workflow.

For other services in the set workflow, execution devices in the individual services in the workflow are set as the user sets conditions in the selected service as parameters, and selects and designates execution devices from the list of devices matching the conditions as done in the steps S4 to S6 (steps S7 to S12).

When setting of the workflow including execution devices in the individual services is completed, and an operation for execution is made through the input unit 11 of the client PC 1, the client PC 1 sends a workflow execution request to the server 2 together with information on the workflow set at the steps S4 to S12, the conditions set as the parameters for the individual services, and the execution devices in the individual devices (step S13).

The setting-condition storing unit 21 of the server 2 stores the sent set conditions, and based on the set workflow, the workflow executing unit 22 sends an execution device for each service in the set workflow in the order from the first service (process I) input/output information that is executed by the execution device, the conditions set as the parameters, and a service execution request (step S14).

In the example shown in FIG. 5, the execution device in the first service is set as the device [F1].

The execution device that has received the service execution request executes the service based on the sent conditions, and outputs data to the output destination according to the set workflow (step S15).

The example shown in FIG. 5 is an operation where the execution device [F1] in the first service scans a document image, and sends the scanned image data to the execution device [F2] in the second service (process II).

When execution of the service requested by the device having receiving the service execution request is completed, the execution result is sent as a report to the server 2 (step S16). The execution-result collecting unit 24 of the server 2 stores the sent report in association with the device name.

When the execution result report is sent, the workflow executing unit 22 of the server 2 sends an execution device in the next service input/output information that is executed by the execution device, the conditions set as the parameters, and the service execution. request (step S17).

The server 2 makes a set device to execute the service based on the set workflow, and receives a sent execution result report as done at the steps S15 and S16 (steps S18 and S19). Likewise, the server 2 makes the set devices to execute the respective service based on the set workflow, and receives sent execution result reports.

When execution of the last service in the set workflow and reception of the last execution result report are completed (steps S20 and S21), the workflow executing unit 22 of the server 2 sends execution result reports in the services stored in the execution-result collecting unit 24 together to the client PC 1 (step S22).

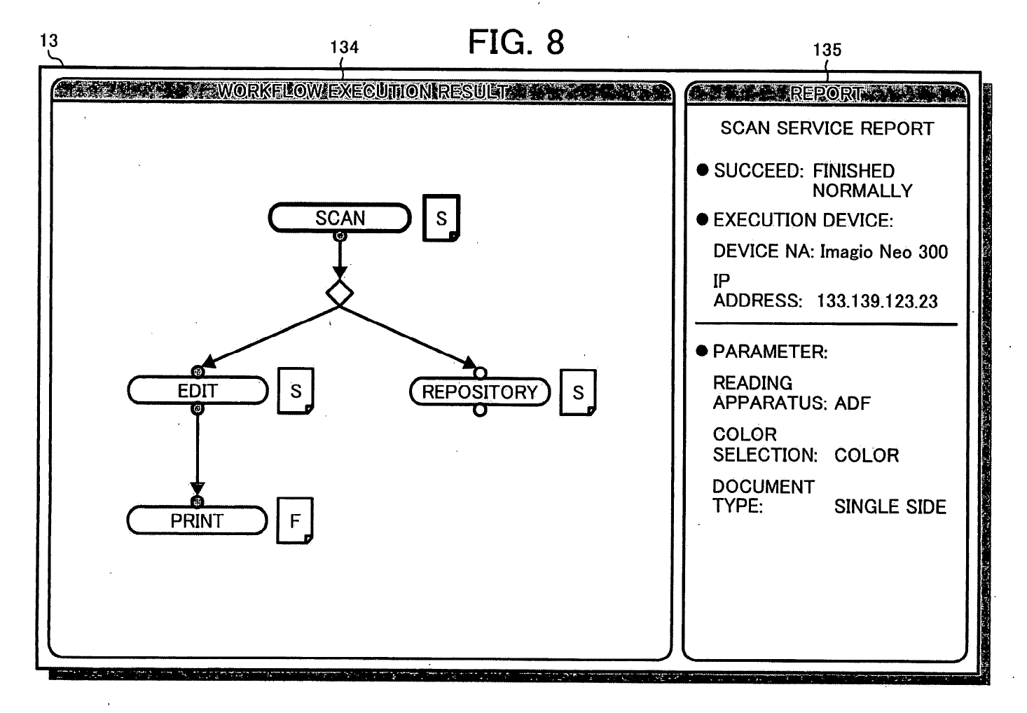

The operation control unit 12 of the client PC 1 that has received the sent information constructs an execution result screen as shown in FIG. 8, and displays the screen on the display unit 13 (step S23).

On the execution result screen, a workflow execution result 134 indicating the result of executing the entire workflow, and a service report 135 indicating the result of executing the selected service are displayed on the display unit 13.

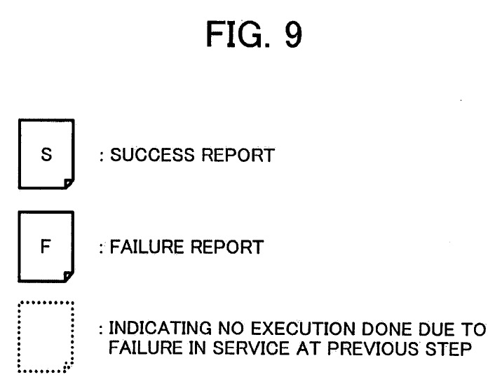

The workflow execution result 134 shows the entire workflow, and as shown in FIG. 9, shows the results of execution of the individual services in the workflow, classified into success, failure, and a case where no service is executed due to a service failure in the previous step. For example, the execution result of “Scan” is “S” indicative of success, and the execution result of “Print” is “F” indicative of failure.

The service report 135 displays a detailed result report for the service selected by the workflow execution result 134. In the example shown in FIG. 8, the name of the execution device, and an IP address are displayed as information on the execution device in the selected “Scan” service in addition to the classification into the success, failure, and the case where no service is executed due to a service failure in the previous step. As conditions set as parameters when the service is executed, the type of the reading apparatus, the distinction between color and monochrome, and the distinction between single side of the document and the double sides thereof are displayed.

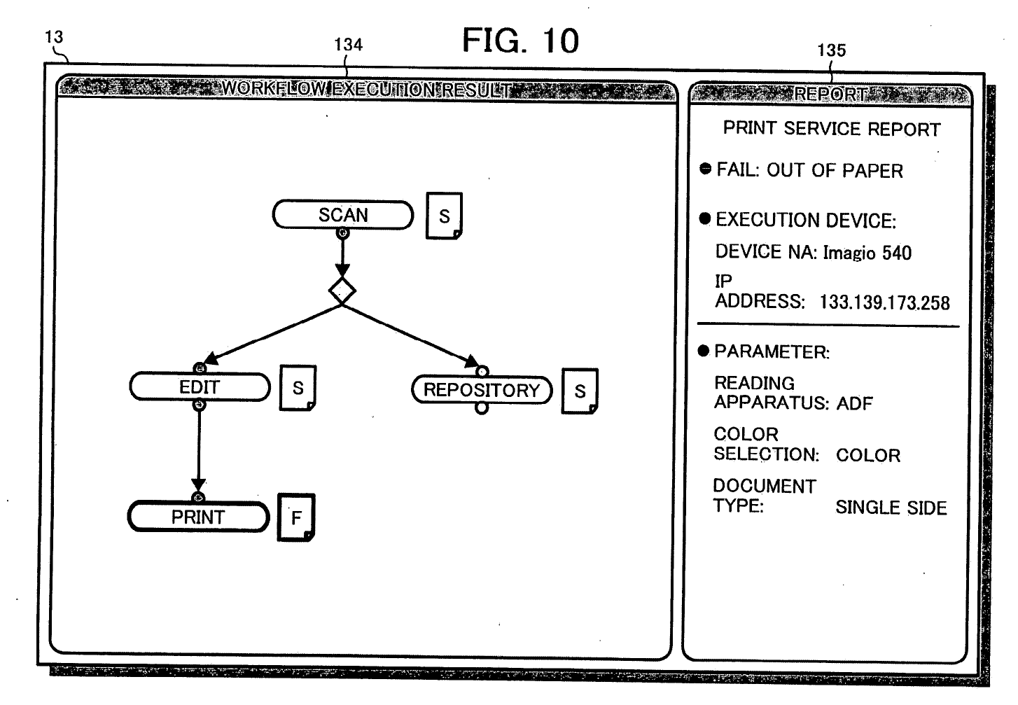

FIG. 10 is a schematic for illustrating an example of the execution result screen for a device that has failed in executing a service.

In the example shown in FIG. 10, the cause of the failure in the execution of the “Print” service selected in the workflow execution result 134, the name of the execution device and the IP address are displayed on the service report 135. As conditions set as parameters when the service is executed, the distinction between color and monochrome, and the distinction between single side of the document and the double sides thereof are displayed.

As the client PC 1 displays the execution result screen shown in FIG. 8 or FIG. 10, the user can know the execution result of a service in the set workflow without moving to the position of the execution device, i.e., without moving to the position of the client PC 1 that has performed the execution operation. Accordingly, the failed service on the workflow and the cause of the failure can be determined easily, making it easier to maintain the failed device, or change the failed device to an executable device. This can improve the operability when the workflow is executed.

According to the present invention, even under the environment where plural devices. of different specifications that can execute the same service are connected together, information on devices matching the set conditions for executing the services can be acquired and set. This can ensure effective support of the construction of the workflow.

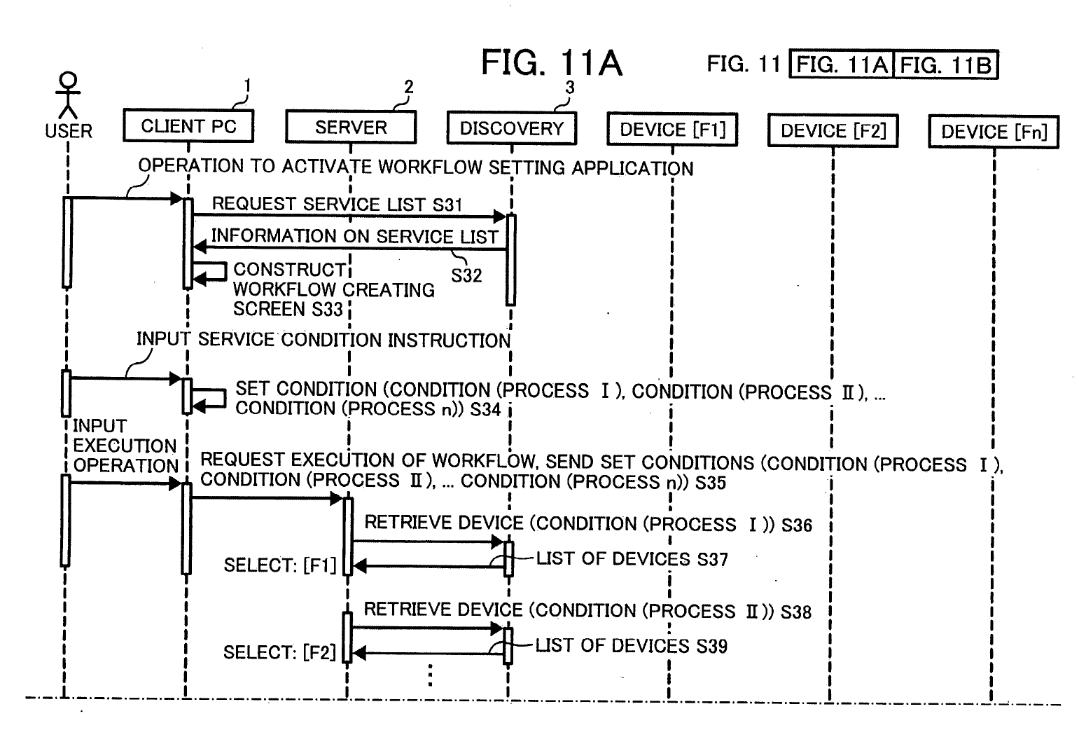

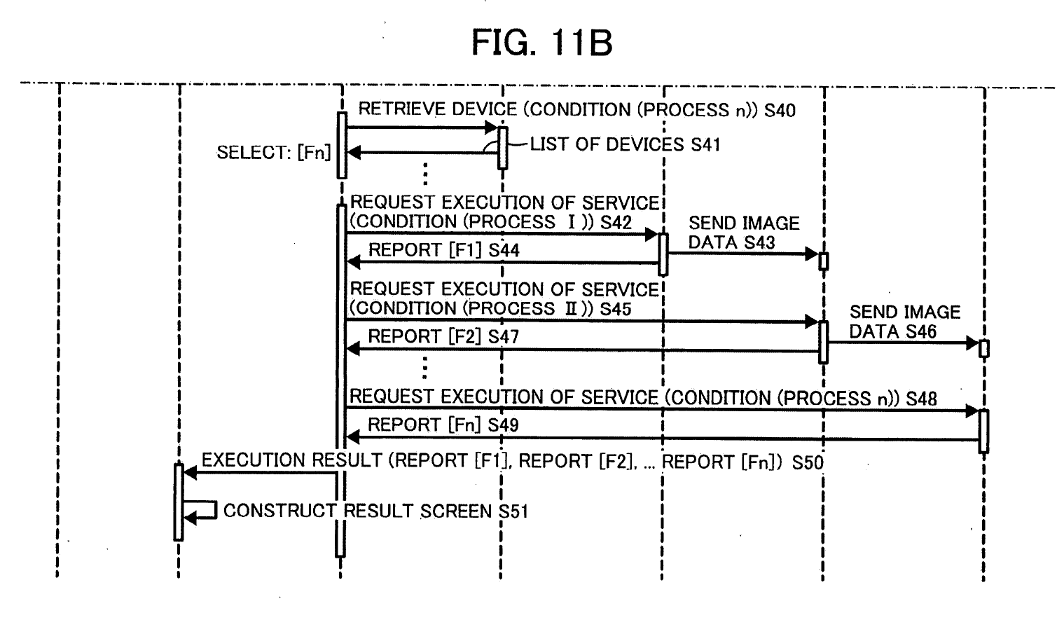

With reference to a flowchart shown in FIG. 11, a description is given of a case where the user selects a mode for automatically selecting an execution device that executes a service set in the workflow.

When the user operates the input unit 11 of the client PC 1 to activate the workflow setting application, the operation control unit 12 of the client PC 1 acquires information on a list of available services from the discovery 3, creates, for example, a workflow creating screen shown in FIG. 6 as mentioned above, and displays the screen on the display unit 13 like the steps S1 to S3 (steps S31 to S33).

With the workflow creating screen displayed on the display unit 13, when the user newly sets a workflow, services in the workflow for executing intended processes can be set easily through simple operations, such as pasting target services on the workflow display unit 132 by click and drag, and connecting the services by connection arrows or the branch symbol according to the connection restrictions.

For the service selected on the workflow display unit 132 on the example of the screen shown in FIG. 6, when the user sets the parameters for the service using the service property 133 and sets “Auto” for selection of the execution device, the client PC 1 sets the set parameters as conditions for the selected service of the workflow (step S34).

When the parameters in each service in the workflow are set, setting of the workflow with the selection of the execution device being “Auto” is completed, and an operation for execution is made through the input unit 11 of the client PC 1, the client PC 1 sends a workflow execution request to the server 2 together with information on the workflow set at the step S34, and the conditions set as the parameters for the individual services (step S35).

The setting-condition storing unit 21 of the server 2 stores the sent set conditions, and when the device-in-charge determining unit 23 confirms based on the set workflow that the execution device for the first service (process I) is set to “Auto”, the device-in-charge determining unit 23 inquires the discovery 3 of a device that matches best with the conditions of the set parameters (step S36).

Upon reception of the retrieval request for a device matching the conditions, the network-status control unit 33 of the discovery 3 refers to the network-status storing unit 32 to select devices matching the conditions from the information on available devices in the image output system at this point of time, creates information on a list of the devices, and sends the information on the list of the matching devices to the server 2 (step S37).

Upon reception of the list of matching devices, the device-in-charge determining unit 23 of the server 2 selects a most preferable device to be used from the devices according to a predetermined priority order. There can be various methods of selecting a most preferable device, such as preceding a device with the lowest cost, preceding a device that has the lightest traffic in the network, and preceding the first device hit in the retrieval.

In the example shown in FIG. 11, the optimal execution device in the first service is selected as the device [F1].

For each service in the set workflow, the device-in-charge determining unit 23 inquiries the discovery 3 of any execution device that is set to “Auto”, sequentially acquires information on a list of matching devices for the service, and sequentially selects the optimal device in use from the acquired information on the list of matching devices through the same operations as done at the steps S36 and S37 (steps S38 to S41).

When the optimal device in use for each service whose execution device is set to “Auto” is selected in the above manner, the workflow executing unit 22 of the server 2 sends input/output information that is executed by an associated execution device according to the set workflow, the conditions set as the parameters, and the service execution request to the execution device for each service in the set workflow in order from the first service, through the same operations as done at the steps S14 to S16 in the operational example, makes the execution device to execute the service based on the set workflow and output data to the output destination in the set workflow, and receives the execution result report via the execution-result collecting unit 24 (steps S42 to S44).

When the execution result report is sent, the workflow executing unit 22 of the server 2 sends input/output information that is executed by an associated execution device in the next service according to the set workflow, the conditions set as the parameters, and the service execution request to the execution device, through the same operation as done at the step S17 in the operational example (step S45).

Through the same operations, as done at the steps S18 to S19 in the operational example, the workflow executing unit 22 makes the execution device to execute a service based on the set workflow, and receives the sent execution result report (steps S46 and S47). Thereafter, likewise, the workflow executing unit 22 makes an associated execution device to execute each service based on the set workflow, and receives the sent execution result report.

When execution of the last service in the set workflow and reception of the last execution result report are completed (steps S48 and S49), the workflow executing unit 22 of the server 2 sends the execution result reports in the services stored in the execution-result collecting unit 24 together to the client PC 1 (step S50).

The operation control unit 12 of the client PC 1 having received the reports constructs the execution result screen using the screen example shown in FIG. 8 or FIG. 10, and displays the execution result screen on the display unit 13 (step S51).

In the operational example where an execution device is set to “Auto”, when the discovery 3 receives an inquiry about matching devices from the server 2, the discovery 3 sends a list of devices matching the conditions set by the user to the server 2, which in turn selects the optimal execution device in use. The operation of selecting the optimal execution device in use can be achieved similarly by the discovery 3 instead of the server 2.

In this case, the discovery 3 selects a device matching the conditions from information on available devices in the image output system at this point of time, further selects the optimal execution device in use from the devices according to a predetermined order, and sends information on the optimal execution device to the server 2.

Even under the environment where plural devices of different specifications that can execute the same service are connected to the network, the image output system according to the first embodiment can set an execution device from those devices present on the network when creating the workflow based on the conditions designated by the user for each service. It is therefore possible to create a workflow by combining optimal execution devices to achieve the functions desired by the user from all the devices connected to the network, and execute the workflow.

As the image output system according to the first embodiment can select one device or plural devices equipped in each apparatus device by device, and can set the devices for each service in the workflow, so that the user can create a workflow by combining the optimal execution devices and execute the workflow without being conscious about the apparatus that is equipped with the devices.

As the image output system according to the first embodiment can select an execution device according to the functional characteristics of the individual devices by setting parameters on the parameter selection screen, and can combine and set execution devices in the individual services of the workflow easily and freely, the workflow according to the user's purpose can be easily constructed and executed.

Although the foregoing description of the first embodiment has been given of the image output system as one example, the present invention is not limited to the image output system, but can be adapted to any system that has a plurality of devices of different specifications on a network and capable of executing the same service, without being restricted to the types of the services the devices can execute.

Although execution devices in the services in a workflow are either designated or automatically set in each operational example explained above, the designation of an execution device or the automatic setting of an execution device is actually carried out for each service, so that the designation of an execution device and the automatic setting of an execution device can be mixed in the services of a workflow, and can be selectively chosen service by service.

In the case of the mixture of the designation of an execution device and the automatic setting of an execution device, either the operation in the operation example for designating an execution device or the operation in the operation example for automatically setting an execution device is carried out service by service according to the contents of setting in the service.

Although the operational examples explained above designate or automatically set execution devices in the individual services in a workflow, the individual services in a workflow previously registered can be executed by calling the workflow.

That is, with preset workflows registered in association with workflow names, to use the same workflow again, the user can call the registered workflow by operating a “Call” button on the workflow display unit 132. In this case, when a registration operation is done, the operation control unit 12 of the client PC 1 stores individual services in the set workflow, parameters set for the individual services, and set information on execution devices in the storing unit 14 in association with the input workflow name, and when a calling operation is done, the operation control unit 12 reads the set conditions stored in the storing unit 14 in association with the workflow name, and displays the conditions on the workflow display unit 132.

The use of the function of calling a set workflow can eliminate the work of creating the same workflow again.

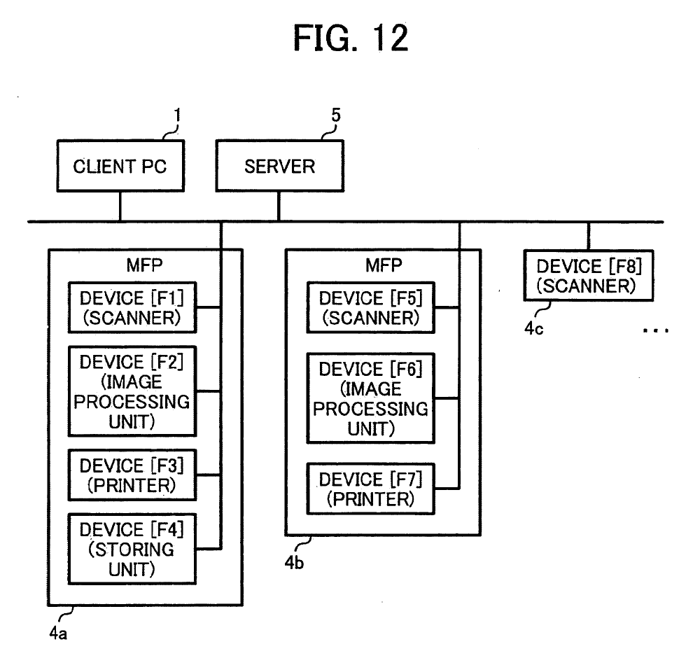

FIG. 12 is a block diagram of an image output system according to a second embodiment of the present invention.

The image output system according to the second embodiment includes the client PC 1, a server 5, and devices having functions to execute services, all connected to one another via a network.

Each device is connected to the network, and includes a plurality of devices of different specifications capable of executing the same service.

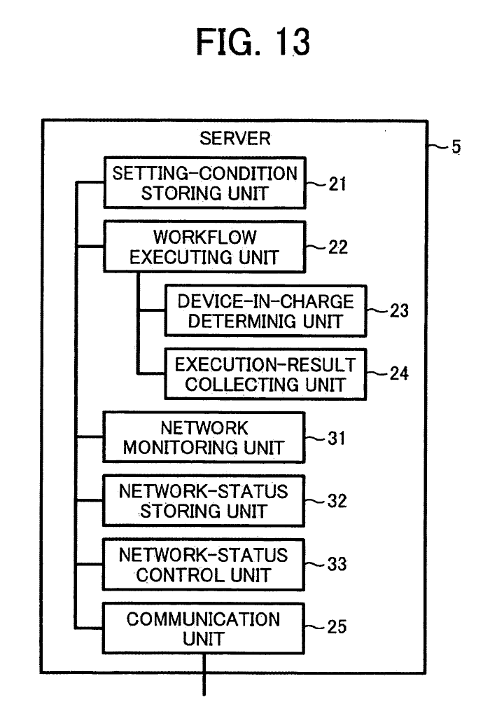

FIG. 13 is a block diagram of the server 5 used in the image output system according to the second embodiment. The server 5 includes the setting-condition storing unit 21, the workflow executing unit 22, the device-in-charge determining unit 23, the execution-result collecting unit 24, the communication unit 25, the network monitoring unit 31, the network-status storing unit 32, and the network-status control unit 33, thereby achieving the functions of the server 2 and the discovery 3 according to the first embodiment.

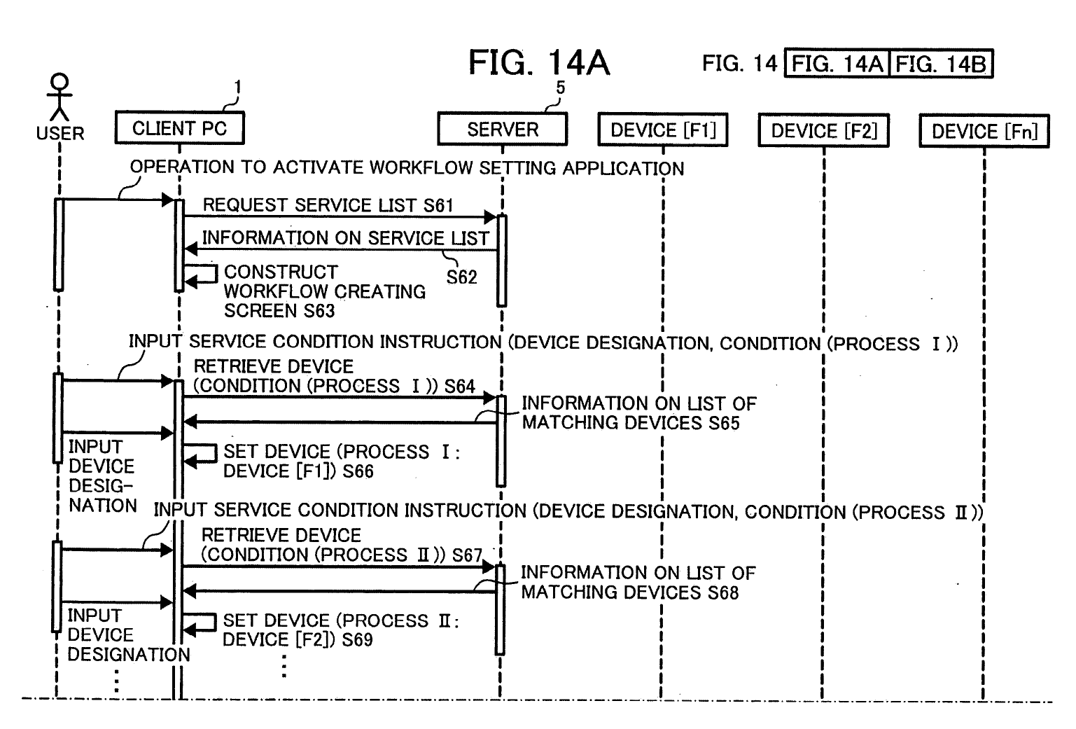

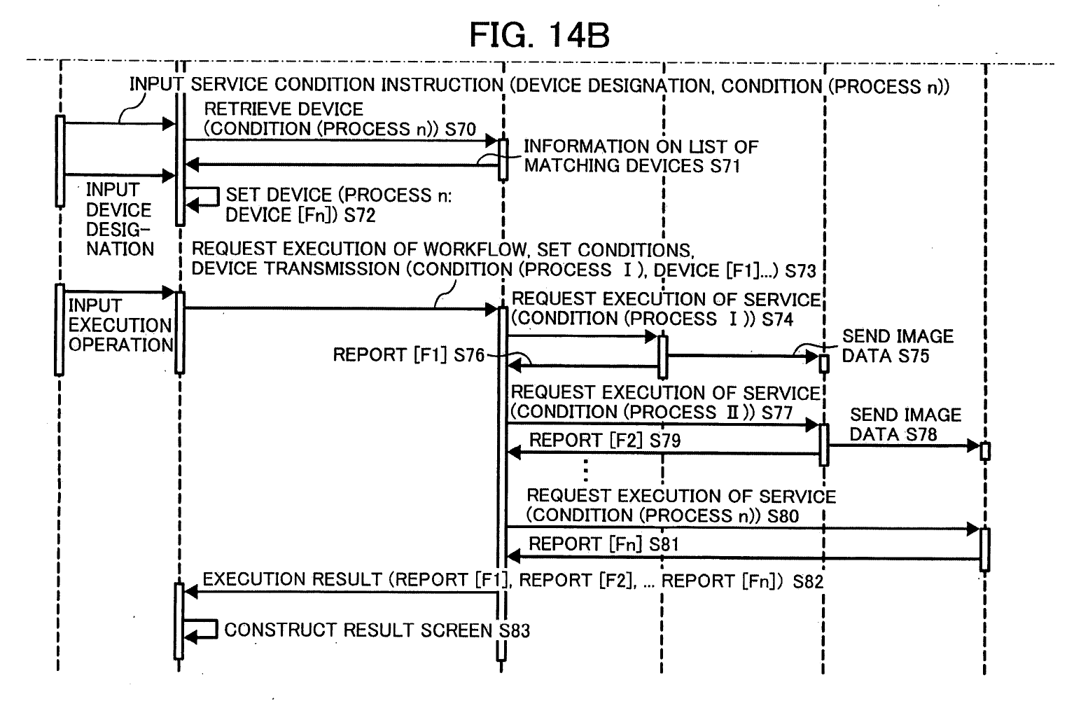

FIG. 14 is a sequence diagram of an operational example when an execution device is designated in the image output system according to the second embodiment.

When the user operates the input unit 11 of the client PC 1 to activate a workflow setting application, the operation control unit 12 of the client PC 1 requests the server 5 of a list of available services by the communication unit 15 (step S61).

Upon reception of the request of the service list, the network-status control unit 33 of the server 5 refers to the network-status storing unit 32 to create information on a list of executable services from information on available devices in the image output system at this point of time, and sends the information on the service list to the client PC 1 (step S62).

Upon reception of the information on the service list, the client PC 1 constructs a workflow creating screen, such as one described above, by referring to the example of the screen shown in FIG. 6, and displays the screen on the display unit 13 (step S63).

When the workflow creating screen is displayed on the display unit 13, and the user sets parameters for the service, selected on the workflow display unit 132, using the service property 133, the client PC 1 inquires the server 5 of devices matching the conditions of the set parameters (step S64).

Upon reception of the retrieval request for a device matching the condition, the network-status control unit 33 of the server 5 refers to the network-status storing unit 32 to create information on a list of matching devices from information on available devices in the image output system at this point of time, and sends the information on the matching device list to the client PC 1 (step S65).

Upon reception of the list of matching devices, the client PC 1 displays the list of matching devices on the execution-device selection screen of the service property 133. When the user designates any device from the displayed list of devices, the client PC 1 sets the designated device as an execution device in the selected service (step S66).

For other services in the set workflow, execution devices in the individual services in the workflow are set as the user sets conditions in the selected service as parameters, and selects and designates execution devices from the list of devices matching the conditions as done in the steps S64 to S66 (steps S67 to S72).

When setting of the workflow including execution devices in the individual services is completed, and an operation for execution is made through the input unit 11 of the client PC 1, the client PC 1 sends a workflow execution request to the server 5 together with information on the workflow set at the steps S64 to S72, the conditions set as the parameters for the individual services, and the execution devices in the individual devices (step S73).

The setting-condition storing unit 21 of the server 5 stores the sent set conditions, and based on the set workflow, the workflow executing unit 22 sends an execution device for each service in the set workflow in the order from the first service (process I) input/output information that is executed by the execution device, the conditions set as the parameters, and a service execution request (step S74).

In the example shown in FIG. 14, the execution device in the first service is set as the device [F1].

The execution device that has received the service execution request executes the service based on the sent conditions, and outputs data to the output destination according to the set workflow (step S75).

The example shown in FIG. 14 is an operation where the execution device [F1] in the first service scans a document image, and sends the scanned image data to the execution device [F2] in the second service (process II).

When execution of the service requested by the device having receiving the service execution request is completed, the execution result is sent as a report to the server 5 (step S76). The execution-result collecting unit 24 of the server 5 stores the sent report in association with the device name.

When the execution result report is sent, the workflow executing unit 22 of the server 5 sends an execution device in the next service input/output information that is executed by the execution device, the conditions set as the parameters, and the service execution request (step S77).

The server 5 makes a set device to execute the service based on the set workflow, and receives a sent execution result report as done at the steps S75 and S76 (steps S78 and S79). Likewise, the server 5 makes the set devices to execute the respective service based on the set workflow, and receives sent execution result reports.

When execution of the last service in the set workflow and reception of the last execution result report are completed (steps S80 and S81), the workflow executing unit 22 of the server 5 sends execution result reports in the services stored. in the execution-result collecting unit 24 together to the client PC 1 (step S82).

The operation control unit 12 of the client PC 1 that has received the sent information constructs an execution result screen, such as one described above, by referring to the screen example shown in FIG. 8 or FIG. 10, and displays the screen on the display unit 13 (step S83).

As the client PC 1 displays the execution result screen as shown in FIG. 8 or FIG. 10, the user can find out the result of executing a service in the set workflow without moving to the position of the execution device, i.e., without moving from the position of the client PC 1 that has made the execution operation.

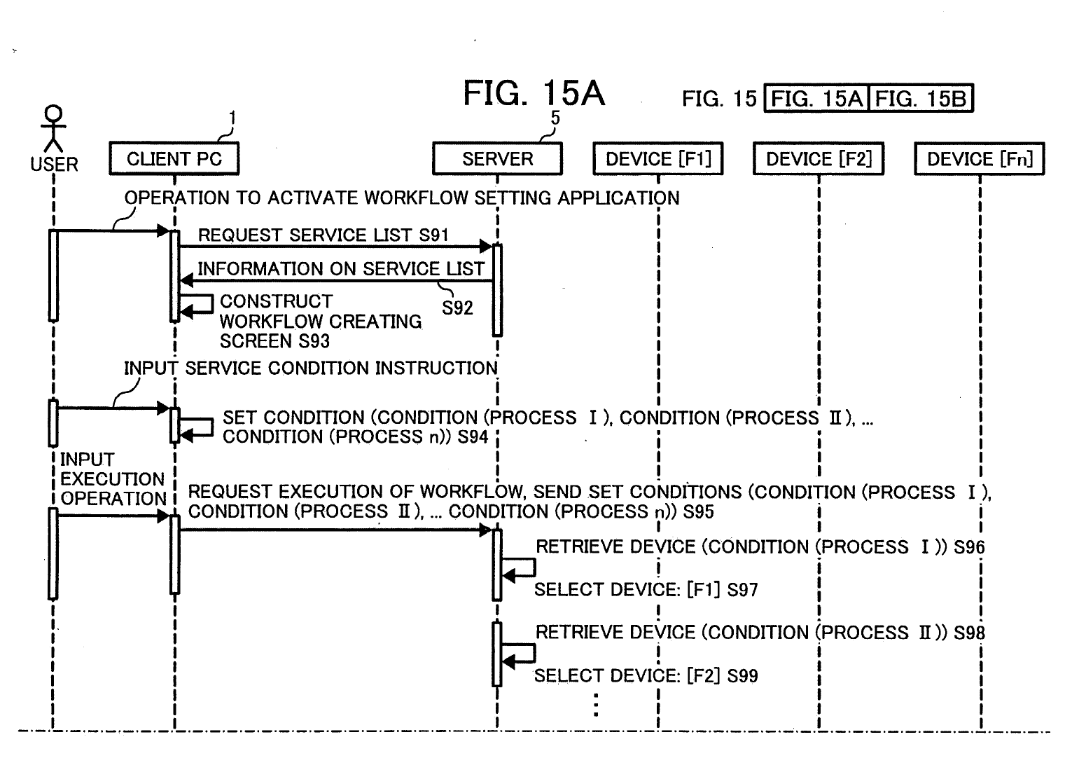

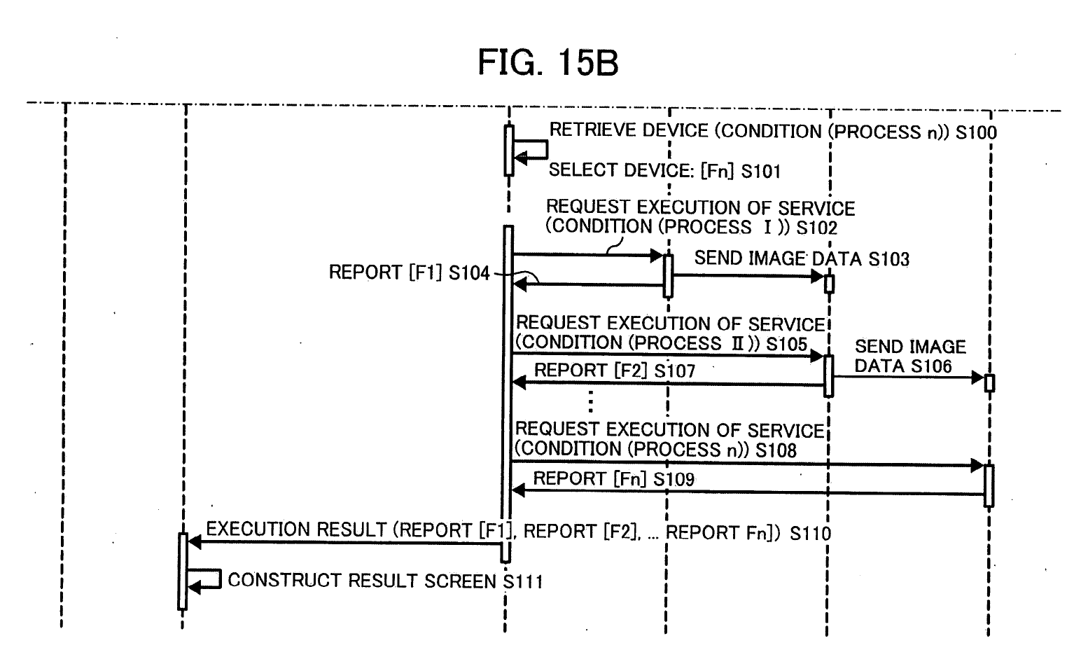

With reference to a flowchart shown in FIG. 15, a description is given of a case where the user selects a mode for automatically selecting an execution device that executes a service set in the workflow.

When the user operates the input unit 11 of the client PC 1 to activate the workflow setting application, the operation control unit 12 of the client PC 1 acquires information on a list of available services from the server 5, creates, for example, a workflow creating screen shown in FIG. 6 as mentioned above, and displays the screen on the display unit 13 through the same operations as done at the steps S61 to S63 (steps S91 to S93).

With the workflow creating screen displayed on the display unit 13, when the user newly sets a workflow, services in the workflow for executing intended processes can be set easily through simple operations, such as pasting target services on the workflow display unit 132 by click and drag, and connecting the services by connection arrows or the branch symbol according to the connection restrictions.

For the service selected on the workflow display unit 132 on the example of the screen shown in FIG. 6, when a user sets the parameters for the service using the service property 133 and sets “Auto” for selection of the execution device, the client PC 1 sets the set parameters as conditions for the selected service of the workflow (step S94).

When the parameters in each service in the workflow are set, and setting of the workflow with the selection of the execution device being “Auto” is completed, and an operation for execution is made through the input unit 11 of the client PC 1, the client PC 1 sends a workflow execution request to the server 5 together with information on the workflow set at the step S64, and the conditions set as the parameters for the individual services (step S95).

The setting-condition storing unit 21 of the server 5 stores the sent set conditions, and when the device-in-charge determining unit 23 confirms based on the set workflow that the execution device for the first service (process I) is set to “Auto”, the device-in-charge determining unit 23 inquires the network-status control unit 33 of a device that matches best with the conditions of the set parameters (step S96).

Upon reception of a retrieval request for a device matching the conditions, the network-status control unit 33 refers to the network-status storing unit 32 to select devices matching the conditions from the information on available devices in the image output system at this point of time, creates information on.a list of the devices, and sends the information on the list of the matching devices to the device-in-charge determining unit 23 (step S97).

Upon reception of the list of matching devices, the device-in-charge determining unit 23 selects an optimal device to be used from the devices according to a predetermined order. There can be various methods of selecting an optimal device, such as preceding a device with the lowest cost, preceding a device that has the lightest traffic in the network, and preceding the first device hit in the retrieval.

In the example shown in FIG. 15, the optimal execution device in the first service is selected as the device [F1].

For each service in the set workflow, the device-in-charge determining unit 23 inquiries the discovery 3 of any execution device that is set to “Auto”, sequentially acquires information on a list of matching devices for the service, and sequentially selects the optimal device in use from the acquired information on the list of matching devices through the same operations as done at the steps S96 and S97 (steps S98 to S101).

When the optimal device in use for each service whose execution device is set to “Auto” is selected in the above manner, the workflow executing unit 22 of the server 5 sends input/output information that is executed by an associated execution device according to the set workflow, the conditions set as the parameters, and the service execution request to the execution device for each service in the set workflow in order from the first service, through the same operations as done at the steps S74 to S76 in the operational example, makes the execution device to execute the service based on the set workflow and output data to the output destination in the set workflow, and receives the execution result report via the execution-result collecting unit 24 (steps S102 to S104).

When the execution result report is sent, the workflow executing unit 22 of the server 5 sends input/output information that is executed by an associated execution device in the next service according to the set workflow, the conditions set as the parameters, and the service execution request to the execution device, through the same operation as done at the step S77 in the operational example (step S105).

Through the same operations as done at the steps S78 and S79 in the operational example, the workflow executing unit 22 makes the execution device to execute a service based on the set workflow, and receives the sent execution result report (steps S106 and S107) Thereafter, likewise, the workflow executing unit 22 makes an associated execution device to execute each service based on the set workflow, and receives the sent execution result reports.

When execution of the last service in the set workflow and reception of the last execution result report are completed (steps S108 and S109), the workflow executing unit 22 of the server 5 sends the execution result reports in the services stored in the execution-result collecting unit 24 together to the client PC 1 (step S110).

The operation control unit 12 of the client PC 1 having received the reports constructs the execution result screen using the screen example shown in FIG. 8 or FIG. 10, and displays the execution result screen (step S111).

As the image output system according to the second embodiment takes the configuration, the control of the image output system can be managed intensively with fewer apparatuses.

The image output system according to the second embodiment can bring about effects similar to those of the first embodiment, even when it is configured that the server includes the discovery function instead of being configured to include the client PC 1, the server 2, and the discovery 3.

Although execution devices in the services in a workflow are either designated or automatically set in each operational example explained above, the designation of an execution device or the automatic setting of an execution device is actually carried out for each service, so that the designation of an execution device and the automatic setting of an execution device can be mixed in the services of a workflow, and can be selectively chosen service by service.

In the case of the mixture of the designation of an execution device and the automatic setting of an execution device, either the operation in the operation example for designating an execution device or the operation in the operation example for automatically setting an execution device is carried out service by service according to the contents of setting in the service.

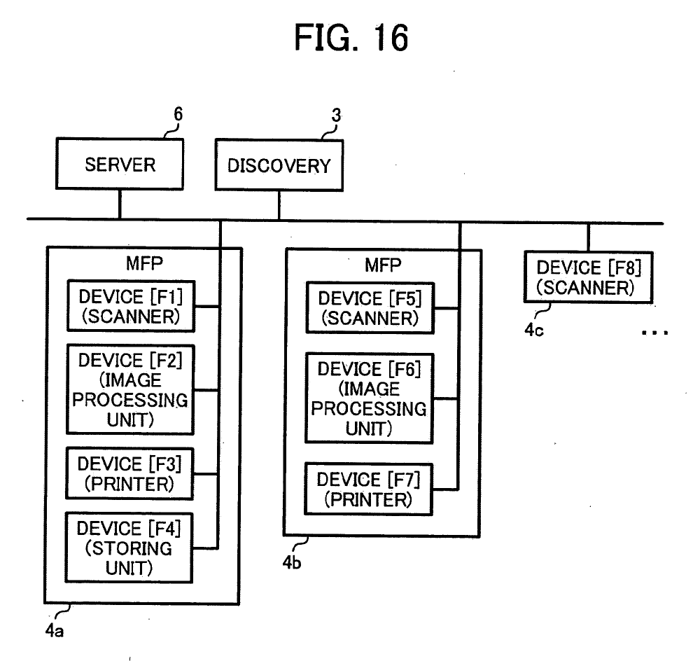

FIG. 16 is a block diagram of an image output system according to a third embodiment of the present invention. The image output system according to the third embodiment includes a server 6, the discovery 3, and devices having functions to execute services, all connected to one another via a network.

Each device is connected to the network, and includes a plurality of devices of different specifications capable of executing the same service.

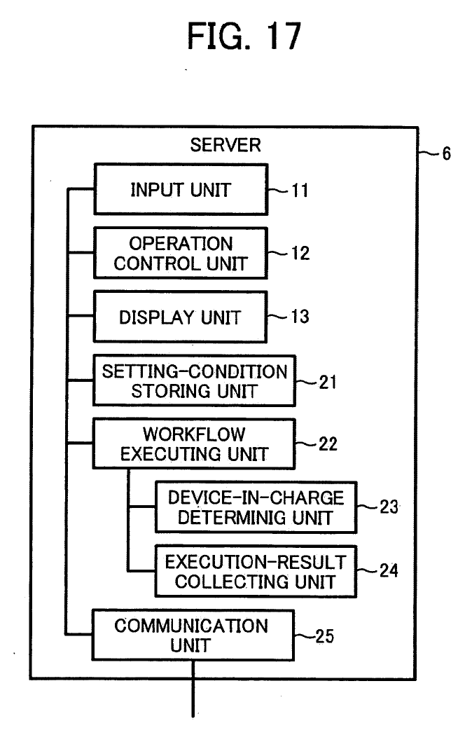

FIG. 17 is a block diagram of the server 6 used in the image output system according to the third embodiment. The server 6 includes the input unit 11, the operation control unit 12, the display unit 13, the setting-condition storing unit 21, the workflow executing unit 22, the device-in-charge determining unit 23, the execution-result collecting unit 24, and the communication unit 25, thereby achieving the functions of the client PC 1 and the server 2 according to the first embodiment.

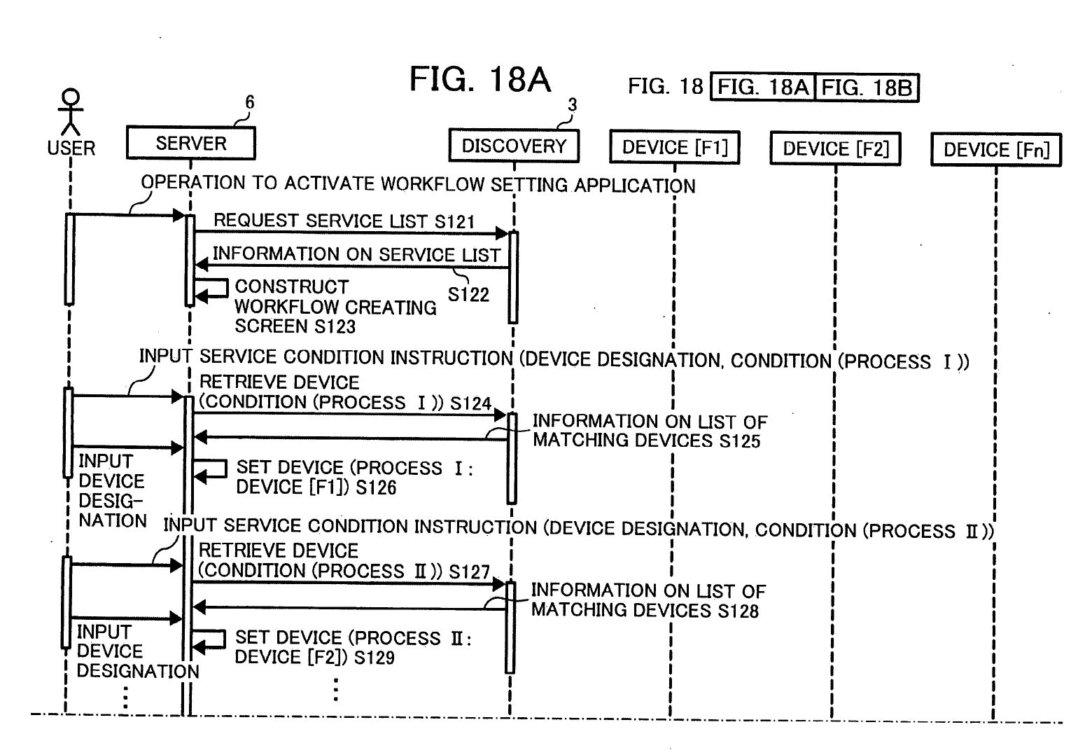

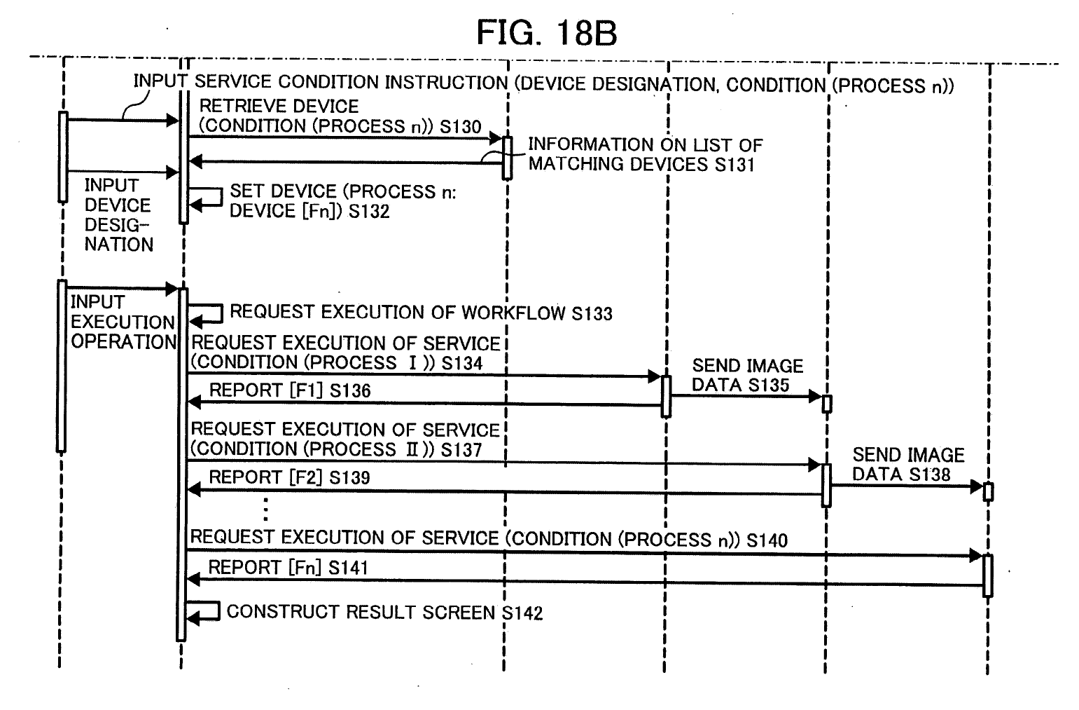

FIG. 18 is a sequence diagram of an operational example when the execution device is designated in the image output system according to the third embodiment.

When the user operates the input unit 11 of the server 6 to activate a workflow setting application, the operation control unit 12 requests the discovery 3 of a list of available services (step S121).

Upon reception of the request of the service list, the network-status control unit 33 of the discovery 3 refers to the network-status storing unit 32 to create information on a list of executable services from information on available devices in the image output system at this point of time, and sends the information on the service list to the server 6 (step S122).

Upon reception of the information on the service list, the server 6 constructs a workflow creating screen, such as one described above, by referring to the example of the screen shown in FIG. 6, and displays the screen on the display unit 13 (step S123).

When the workflow creating screen is displayed on the display unit 13, and the user sets parameters for the service, selected on the workflow display unit 132, using the service property 133, the server 6 inquires the discovery 3 of devices matching the conditions of the set parameters (step S124).

Upon reception of the retrieval request for a device matching the condition, the network-status control unit 33 of the discovery 3 refers to the network-status. storing unit 32 to create information on a list of matching devices from information on available devices in the image output system at this point of time, and sends the information on the matching device list to the server 6 (step S125).

Upon reception of the list of matching devices, the operation control unit 12 of the server 6 displays the list of matching devices on the execution-device selection screen of the service property 133. When the user designates any device from the displayed list of devices, the operation control unit 12 sets the designated device as an execution device in the selected service (step S126).

For other services in the set workflow, execution devices. in the individual services in the workflow are set as the user sets conditions in the selected service as parameters, and selects and designates execution devices from the list of devices matching the conditions as done in the steps S124 to S126 (steps S127 to S132).

When setting of the workflow including execution devices in the individual services is completed, and an operation for execution is made through the input unit 11 of the server 6, the operation control unit 12 stores the workflow set at the steps S124 to S132, the conditions set as the parameters for the individual services, and information on the execution devices in the individual services in the setting-condition storing unit 21, and requests the workflow executing unit 22 to execute the workflow (step S133).

Based on the set workflow, the workflow executing unit 22 of the server 6 sends input/output information that is executed by the execution device, the conditions set as the parameters, and a service execution request to an associated execution device for each service in the set workflow in the order from the first service (process I) (step S134).

In the example shown in FIG. 18, the execution device in the first service is set as the device [F1].

The execution device that has received the service execution request executes the service based on the sent conditions, and outputs data to the output destination according to the set workflow (step S135).

The example shown in FIG. 18 is an operation where the execution device [F1] in the first service scans a document image, and sends the scanned image data to the execution device [F2] in the second service (process II).

When the execution of the service requested by the device having receiving the service execution request is completed, the execution result is sent as a report to the server 6 (step S136). The execution-result collecting unit 24 of the server 6 stores the sent report in association with the device name.

When the execution result report is sent, the workflow executing unit 22 of the server 6 sends an execution device in the next service input/output information that is executed by the execution device, the conditions set as the parameters, and the service execution request (step S137).

The server 6 makes a set device to execute the service based on the set workflow, and receives a sent execution result report as done at the steps S135 and S136 (steps S138 and S139). Likewise, the server 6 makes the set devices to execute the respective service based on the set workflow, and receives the sent execution result reports.

When execution of the last service in the set workflow and reception of the last execution result report are completed (steps S140 and S141), the operation control unit 12 of the server 6 organizes the execution result reports in the services stored in the execution-result collecting unit 24, constructs an execution result screen, such as one described above, by using the screen example shown in FIG. 8 or FIG. 10, and displays the screen on the display unit 13 (step S142).

As the display unit 13 of the server 6 displays the execution result screen as shown in FIG. 8 or FIG. 10, the user can find out the result of executing a service in the set workflow without moving to the position of the execution device, i.e., without moving from the position of the server 6 that has made the execution operation.

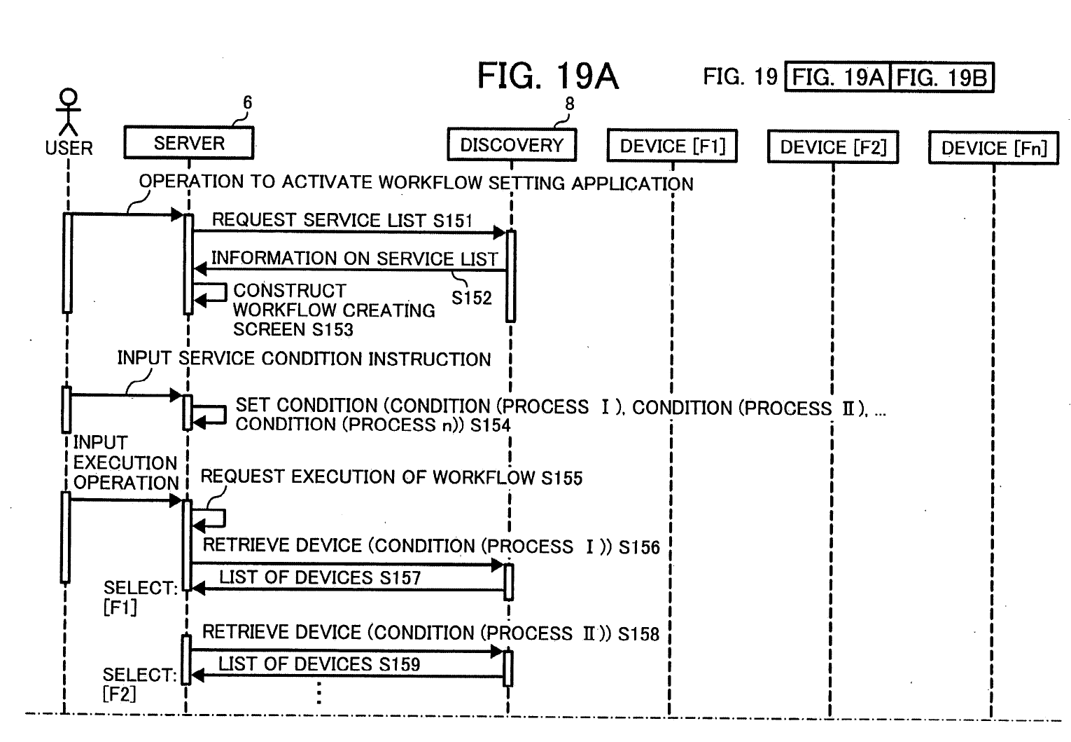

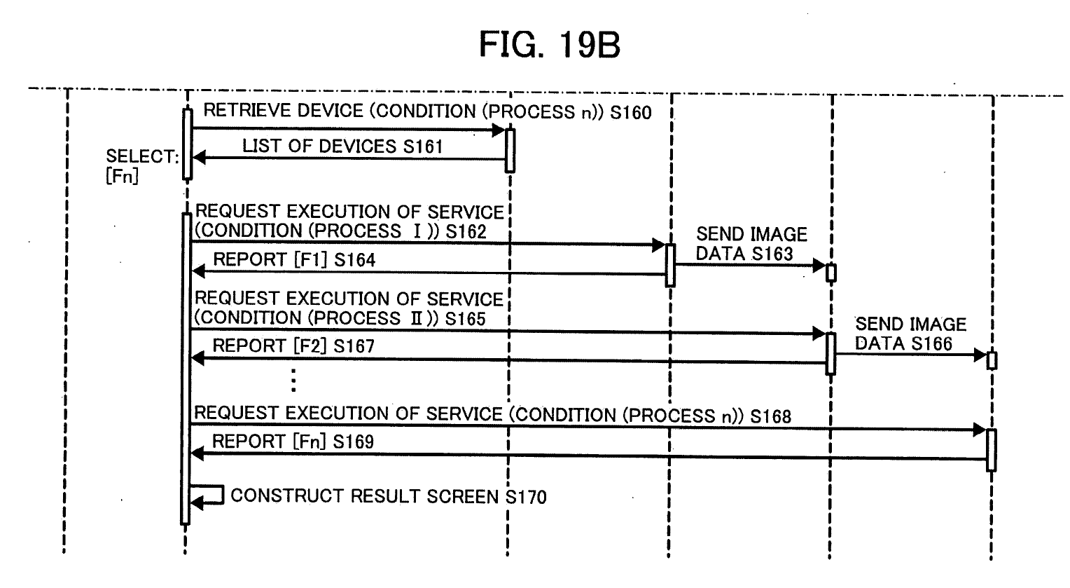

With reference to a flowchart shown in FIG. 19, a description is given of a case where the user selects a mode for automatically selecting an execution device that executes a service set in the workflow.

When the user operates the input unit 11 of the server 6 to activate the workflow setting application, the operation control unit 12 acquires information on a list of available services from the discovery 3, creates, for example, a workflow creating screen shown in FIG. 6 as mentioned above, and displays the screen on the display unit 13 through the same operations as done at the steps S121 to S123 (steps S151 to S153).

With the workflow creating screen displayed on the display unit 13, when the user newly sets a workflow, services in the workflow for executing intended processes can be set easily through simple operations, such as pasting target services on the workflow display unit 132 by click and drag, and connecting the services by connection arrows or the branch symbol according to the connection restrictions.

For the service selected on the workflow display unit 132 on the example of the screen shown in FIG. 6, when the user sets the parameters for the service using the service property 133 and sets “Auto” for selection of the execution device, the operation control unit 12 sets the set parameters as conditions for the selected service of the workflow (step S154).

When the parameters in each service in the workflow are set, setting of the workflow with the selection of the execution device being “Auto” is completed, and an operation for execution is made through the input unit 11 of the server 6, the operation control unit 12 stores the workflow set at the step S154, the conditions set as the parameters for the individual services, and information on the execution devices in the individual services in the setting-condition storing unit 21, and requests the workflow executing unit 22 to execute the workflow (step S155).

When the device-in-charge determining unit 23 of the server 6 confirms based on the set workflow that the execution device for the first service (process I) is set to “Auto”, the device-in-charge determining unit 23 inquires the discovery 3 of a device that matches best with the conditions of the set parameters (step S156).

Upon reception of the retrieval request for a device matching the conditions, the network-status control unit 33 of the discovery 3 refers to the network-status storing unit 32 to select devices matching the conditions from the information on available devices in the image output system at this point of time, creates information on a list of the devices, and sends the information on the list of the matching devices to the server 6 (step S157).

Upon reception of the list of matching devices, the device-in-charge determining unit 23 of the server 6 selects an optimal device to be used from the devices according to a predetermined order. There can be various methods of selecting an optimal device, such as preceding a device with the lowest cost, preceding a device that has the lightest traffic in the network, and preceding the first device hit in the retrieval.

In the example shown in FIG. 19, the optimal execution device in the first service is selected as the device [F1].

For each service in the set workflow, the device-in-charge determining unit 23 inquiries the discovery 3 of any execution device that is set to “Auto”, sequentially acquires information on a list of matching devices for the service, and sequentially selects the optimal device in use from the acquired information on the list of matching devices through the same operations as done at the steps S156 and S157 (steps S158 to S161).

When the optimal device in use for each service whose execution device is set to “Auto” is selected in the above manner, the workflow executing unit 22 of the server 6 sends input/output information that is executed by an associated execution device according to the set workflow, the conditions set as the parameters, and the service execution request to the execution device for each service in the set workflow in order from the first service, through the same operations as done at the steps S134 to S136 in the operational example, makes the execution device to execute the service based on the set workflow and output data to the output destination in the set workflow, and receives the execution result report via the execution-result collecting unit 24 (steps S162 to S164).

When the execution result report is sent, the workflow executing unit 22 of the server 6 sends input/output information that is executed by an associated execution device in the next service according to the set workflow, the conditions set as the parameters, and the service execution request to the execution device, through the same operation as done at the step S137 in the operational example (step S165).

Through the same operations as done at the steps S138 and S139 in the operational example, the workflow executing unit 22 makes the execution device to execute a service based on the set workflow, and receives the sent execution result report (steps S166 and S167). Thereafter, likewise, the workflow executing unit 22 makes an associated execution device to execute each service based on the set workflow, and receives the sent execution result report.

When execution of the last service in the set workflow and reception of the last execution result report are completed (steps S168 and S169), the operation control unit 12 of the server 6 organizes the execution result reports stored in the execution-result collecting unit 24, constructs the execution result screen using the screen example shown in FIG. 8 or FIG. 10, and displays the execution result screen on the display unit 13 (step S170).

In the operational example where an execution device is set to “Auto”, when the discovery 3 receives an inquiry about matching devices from the server 6, the discovery 3 sends a list of devices matching the conditions set by the user to the server 6, which in turn selects the most preferable execution device in use. The operation of selecting the most preferable execution device in use can be achieved similarly by the discovery 3 instead of the server 6.

In this case, the discovery 3 selects a device matching the conditions from information on available devices in the image output system at this point of time, further selects the most preferable execution device in use from the devices according to a predetermined order, and sends information on the most preferable execution device to the server 6.

As the image output system according to the third embodiment takes the configuration, it is unnecessary to provide the client PC for making an operational input to the server, so that the image output system of the present invention can be configured with fewer apparatuses.

The image output system according to the third embodiment can bring about effects similar to those of the first embodiment, even when it is configured that the server includes the discovery function instead of being configured to include the client PC 1, the server 2, and the discovery 3.

Although execution devices in the services in a workflow are either designated or automatically set in each operational example explained above, the designation of an execution device or the automatic setting of an execution device is actually carried out for each service, so that the designation of an execution device and the automatic setting of an execution device can be mixed in the services of a workflow, and can be selectively chosen service by service.

In the case of the mixture of the designation of an execution device and the automatic setting of an execution device, either the operation in the operation example for designating an execution device or the operation in the operation example for automatically setting an execution device is carried out service by service according to the contents of setting in the service.

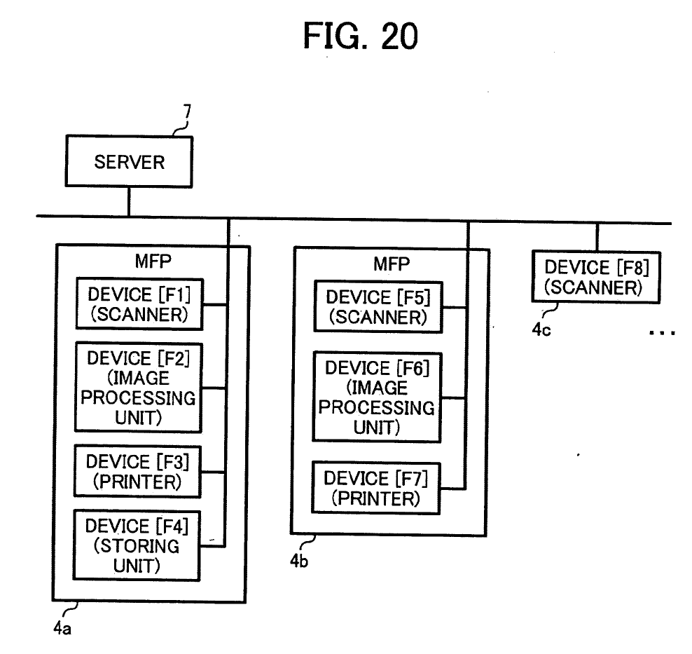

FIG. 20 is a block diagram of an image output system according to a fourth embodiment of the present invention. The image output system according to the fourth embodiment includes a server 7, and devices having functions to execute services, all connected to one another via a network.

Each device is connected to the network, and includes a plurality of devices of different specifications capable of executing the same service.

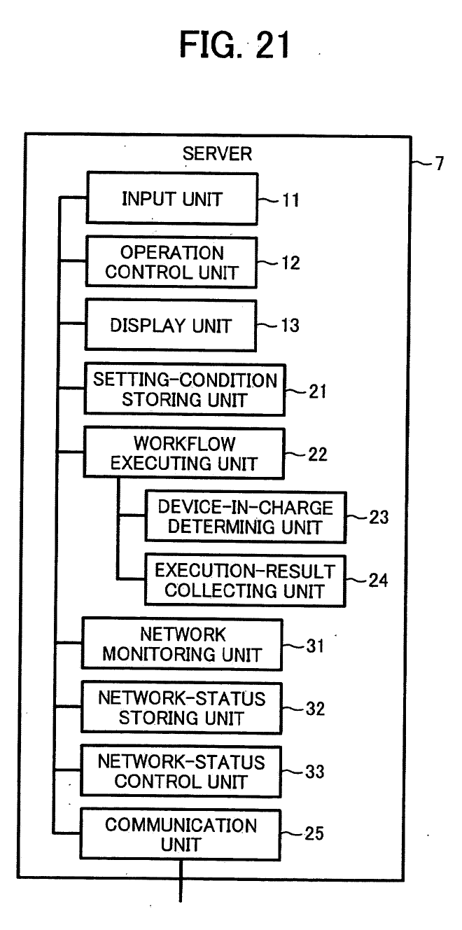

FIG. 21 is a block diagram of the server 7 used in the image output system according to the fourth embodiment. The server 7 includes the input unit 11, the operation control unit 12, the display unit 13, the setting-condition storing unit 21, the workflow executing unit 22, the device-in-charge determining unit 23, the execution-result collecting unit 24, the communication unit 25, the network monitoring unit 31, the network-status storing unit 32, and the network-status control unit 33, thereby achieving the functions of the client PC 1 and the server 2 according to the first embodiment.

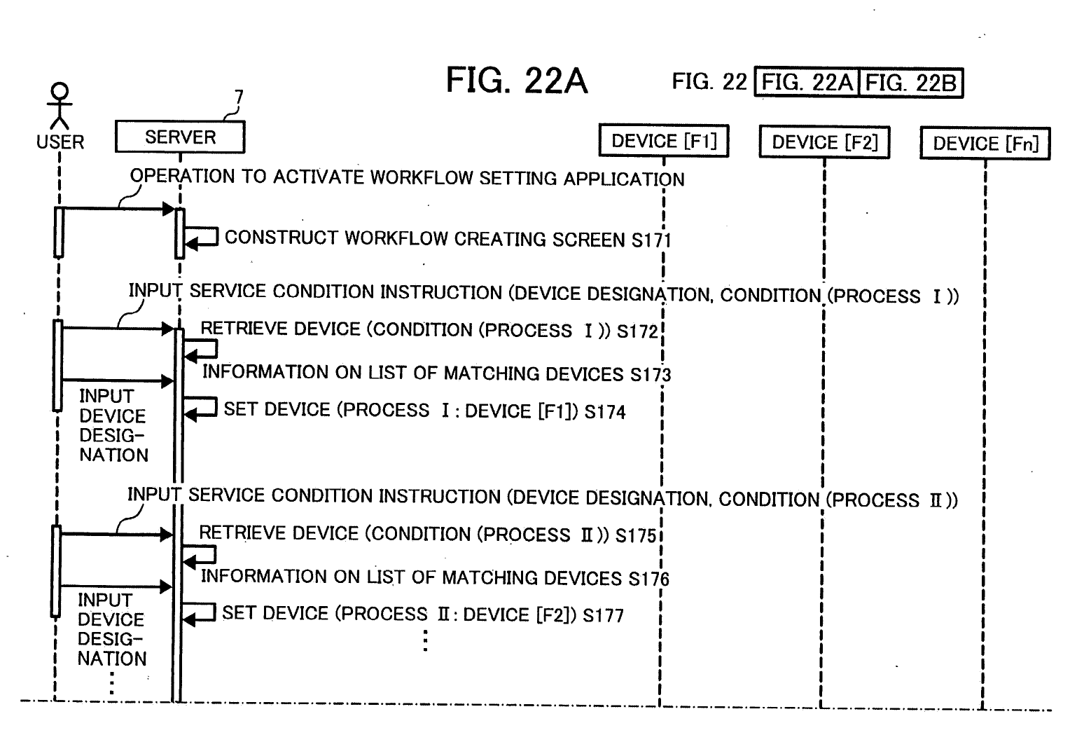

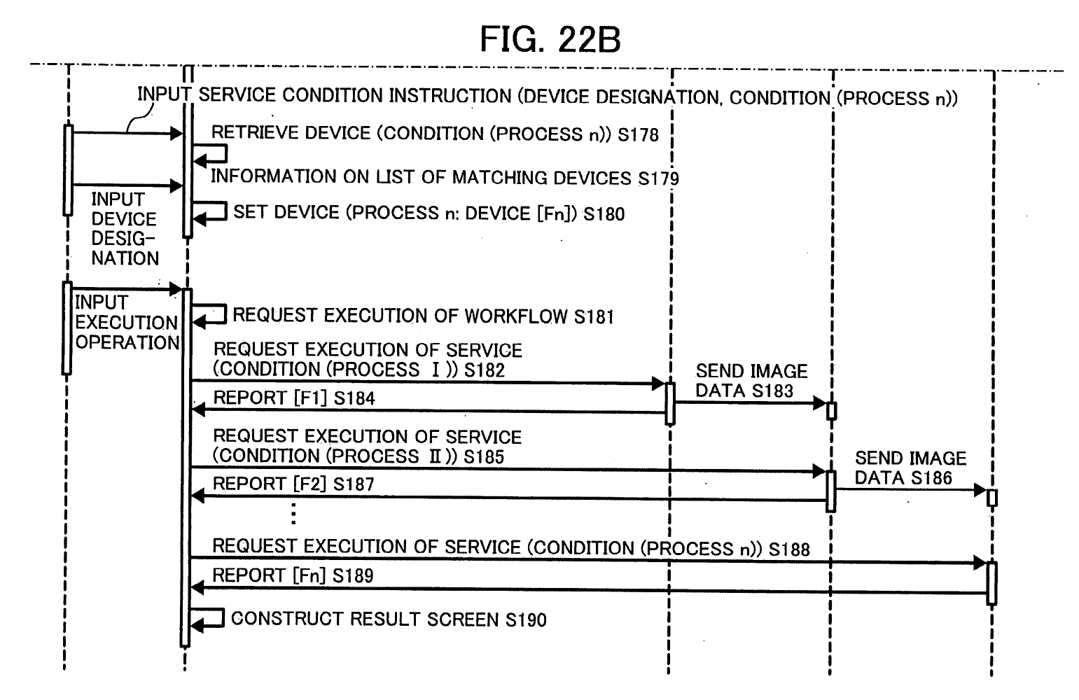

FIG. 22 is a sequence diagram of an operational example when the execution device is designated in the image output system according to the fourth embodiment.

When the user operates the input unit 11 of the server 7 to activate a workflow setting application, the operation control unit 12 requests the network-status control unit 33 of a list of available services.

Upon reception of the request of the service list, the network-status control unit 33 refers to the network-status storing unit 32, and creates information on a list of executable services from information on available devices in the image output system at this point of time. Based on the information on the created service list, the operation control unit 12 constructs a workflow creating screen, such as one described above, by referring to the example of the screen shown in FIG. 6, and displays the screen on the display unit 13 (step S171).

When the workflow creating screen is displayed on the display unit 13, and the user sets parameters for the service, selected on the workflow display unit 132, using the service property 133, the operation control unit 12 inquires the network-status control unit 33 of devices matching the conditions of the set parameters (step S172).

Upon reception of the retrieval request for a device matching the condition, the network-status control unit 33 refers to the network-status storing unit 32, and creates information on a list of matching devices from information on available devices in the image output system at this point of time (step S173). The operation control unit 12 displays the information on the list of matching devices on the execution-device selection screen of the service property 133.

When the user designates any device from the displayed list of devices, the operation control unit 12 sets the designated device as an execution device in the selected service (step S174).

For other services in the set workflow, execution devices in the individual services in the workflow are set as the user sets conditions in the selected service as parameters, and selects and designates execution devices from the list of devices matching the conditions as done in the steps S172 to S174 (steps S175 to S180).

When setting of the workflow including execution devices in the individual services is completed, and an operation for execution is made through the input unit 11 of the server 7, the operation control unit 12 stores the workflow set at the steps S172 to S180, the conditions set as the parameters for the individual services, and information on the execution devices in the individual services in the setting-condition storing unit 21, and requests the workflow executing unit 22 to execute the workflow (step S181).

Based on the set workflow, the workflow executing unit 22 of the server 7 sends input/output information that is executed by the execution device, the conditions set as the parameters, and a service execution request to an associated execution device for each service in the set workflow in the order from the first service (process I) (step S182).

In the example shown in FIG. 22, the execution device in the first service is set as the device [F1].

The execution device that has received the service execution request executes the service based on the sent conditions, and outputs data to the output destination according to the set workflow (step S183).

The example shown in FIG. 22 is an operation where the execution device [F1] in the first service scans a document image, and sends the scanned image data to the execution device [F2] in the second service (process II).

When execution of the service requested by the device having receiving the service execution request is completed, the execution result is sent as a report to the server 7 (step S184). The execution-result collecting unit 24 of the server 7 stores the sent report in association with the device name.

When the execution result report is sent, the workflow executing unit 22 of the server 7 sends an execution device in the next service input/output information that is executed by the execution device, the conditions set as the parameters, and the service execution request (step S185).

The server 7 makes a set device to execute. the service based on the set workflow, and receives a sent execution result report as done at the steps S183 and S184 (steps S186 and S187). Likewise, the server 6 makes the set devices to execute the respective service based on the set workflow, and receives sent execution result reports.

When execution of the last service in the set workflow and reception of the last execution result report are completed (steps S188 and S189), the operation control unit 12 of the server 7 organizes the execution result reports in the services stored in the execution-result collecting unit 24, constructs an execution result screen, such as one described above, by using the screen example shown in FIG. 8 or FIG. 10, and displays the screen on the display unit 13 (step S190).

As the display unit 13 of the server 7 displays the execution result screen as shown in FIG. 8 or FIG. 10, the user can find out the result of executing a service in the set workflow without moving to the position of the execution device, i.e., without moving from the position of the server 7 that has made the execution operation.

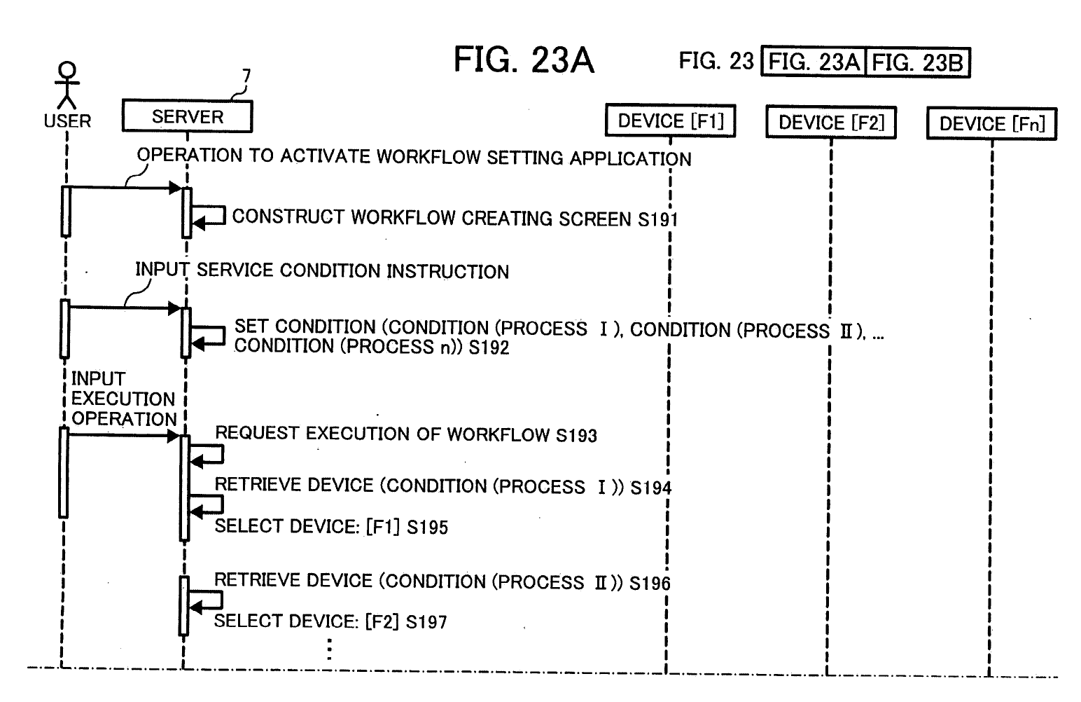

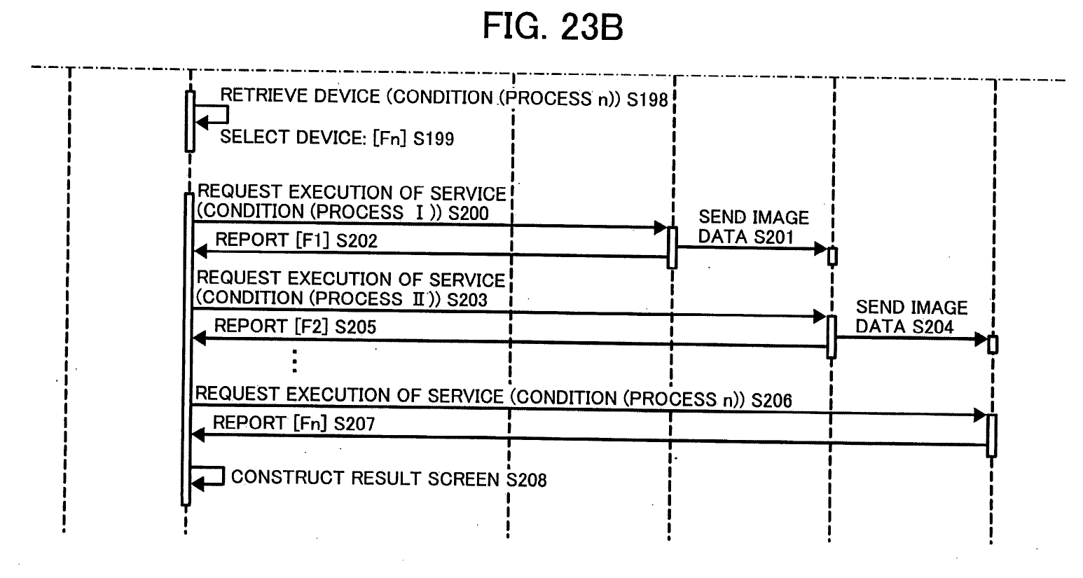

With reference to a flowchart shown in FIG. 23, a description is given of a case where the user selects a mode for automatically selecting an execution device that executes a service set in the workflow.

When the user operates the input unit 11 of the server 7 to activate the workflow setting application, the operation control unit 12 acquires information on a list of available services from the network-status control unit 33, creates, for example, a workflow creating screen shown in FIG. 6 as mentioned above, and displays the screen on the display unit 13 through the same operation as done at the step S171 (steps S191).

With the workflow creating screen displayed on the display unit 13, when the user newly sets a workflow, services in the workflow for executing intended processes can be set easily through simple operations, such as pasting target services on the workflow display unit 132 by click and drag, and connecting the services by connection arrows or the branch symbol according to the connection restrictions.

For the service selected on the workflow display unit 132 on the example of the screen shown in FIG. 6, when a user sets the parameters for the service using the service property 133 and sets “Auto” for selection of the execution device, the operation control unit 12 sets the set parameters as conditions for the selected service of the workflow (step S192).

When the parameters in each service in the workflow are set, setting of the workflow with the selection of the execution device being “Auto” is completed, and an operation for execution is made through the input unit 11, the operation control unit 12 stores the workflow set at the step S192, the conditions set as the parameters for the individual services, and information on the execution devices in the individual services in the setting-condition storing unit 21, and requests the workflow executing unit 22 to execute the workflow (step S193).

When the device-in-charge determining unit 23 of the server 7 confirms based on the set workflow that the execution device for the first service (process I) is set to “Auto”, the device-in-charge determining unit 23 inquires the network-status control unit 33 of a device that matches best with the conditions of the set parameters (step S194).

Upon reception of the retrieval request for a device matching the conditions, the network-status control unit 33 refers to the network-status storing unit 32 to select devices matching the conditions from the information on available devices in the image output system at this point of time, creates information on a list of the devices, and sends the information on the list of the matching devices to the device-in-charge determining unit 23 (step S195).

Upon reception of the list of matching devices, the device-in-charge determining unit 23 selects an optimal device to be used from the devices according to a predetermined order. There can be various methods of selecting an optimal device, such as preceding a device with the lowest cost, preceding a device that has the lightest traffic in the network, and preceding the first device hit in the retrieval.

In the example shown in FIG. 23, the optimal execution device in the first service is selected as the device [F1].

For each service in the set workflow, the device-in-charge determining unit 23 inquiries the network-status control unit 33 of any execution device that is set to “Auto”, sequentially acquires information on a list of matching devices for the service, and sequentially selects the optimal device in use from the acquired information on the list of matching devices through the same operations as done at the steps S194 and S195 (steps S196 to S199).

When the optimal device in use for each service whose execution device is set to “Auto” is selected in the above manner, the workflow executing unit 22 of the server 7 sends input/output information that is executed by an associated execution device according to the set workflow, the conditions set as the parameters, and the service execution request to the execution device for each service in the set workflow in order from the first service, through the same operations as done at the steps S182 to S184 in the operational example, makes the execution device to execute the service based on the set workflow and output data to the output destination in the set workflow, and receives the execution result report via the execution-result collecting unit 24 (steps S200 to S202).

When the execution result report is sent, the workflow executing unit 22 of the server 7 sends input/output information that is executed by an associated execution device in the next service according to the set workflow, the conditions set as the parameters, and the service execution request to the execution device, through the same operation as done at the step S185 in the operational example (step S203).

Through the same operations as done at the steps S186 and S187 in the operational example, the workflow executing unit 22 makes the execution device to execute a service based on the set workflow, and receives the sent execution result report (steps S204 and S205). Thereafter, likewise, the workflow executing unit 22 makes an associated execution device to execute each service based on the set workflow, and receives the sent execution result report.

When execution of the last service in the set workflow and reception of the last execution result report are completed (steps S206 and S207), the operation control unit 12 of the server 7 organizes the execution result reports stored in the execution-result collecting unit 24, constructs the execution result screen using the screen example shown in FIG. 8 or FIG. 10, and displays the execution result screen on the display unit 13 (step S208).

As the image output system according to the fourth embodiment takes the configuration, the control of the image output system can be managed intensively with fewer apparatuses.

The image output system according to the fourth embodiment can bring about effects similar to those of the first embodiment, even when it is configured that the server includes the discovery function instead of being configured to include the client PC 1, the server 2, and the discovery 3.

Although execution devices in the services in a workflow are either designated or automatically set in each operational example explained above, the designation of an execution device or the automatic setting of an execution device is actually carried out for each service, so that the designation of an execution device and the automatic setting of an execution device can be mixed in the services of a workflow, and can be selectively chosen service by service.

In the case of the mixture of the designation of an execution device and the automatic setting of an execution device, either the operation in the operation example for designating an execution device or the operation in the operation example for automatically setting an execution device is carried out service by service according to the contents of setting in the service.

Each of the above embodiments is one exemplary embodiment of the present invention, and the invention is not limited to the present embodiments. Other embodiments can be made with various modifications based on the technical spirit of the invention.

For example, although an MFP and a scanner are connected to the network and the system includes devices that execute services in the present embodiments, the types of the services a single apparatus has can be arbitrary if the system is designed to be able to use the services via the network.

Although the foregoing descriptions of the present embodiments have been given of a case where the final output destination in a workflow is, for example, a printout done by the “Print” service, and the connection restriction discussed with reference to FIGS. 7A to 7E are set as a termination point shown in FIG. 7E, the final output destination in the workflow to be created is not limited to that of the connection restriction, and various kinds of services can be set as the final output destination as long as the services are other than a service whose output should be connected to a succeeding service. For example, even with the final output destination of the workflow being storing unit into the storing unit by the “Repository” service in the screen example shown in FIG. 6, the image output system according to the present invention can create a workflow in the same way.

Although the foregoing descriptions of the present embodiments have been given of a case where the client PC or the server is equipped with the input unit 11 that is operated by the user and the display unit 13, the present embodiment are not limited to those types but can be realized by the structure of, for example, the MFPs 4a, 4b, as long as the apparatus is connected to the network in an operable manner.

Although an execution device in each service in a workflow is designated or automatically set according to the present embodiments, calling a pre-registered workflow can allow each service in the workflow to be executed.

That is, with preset workflows registered in association with workflow names, when the user wants to use the same workflow again, the user can call the registered workflow by operating the “Call” button on the workflow display unit 132. In this case, when a registration operation is done, the operation control unit 12 stores individual services in the set workflow, parameters set for the individual services, and set information on execution devices in the storing unit 14 in association with the input workflow name, and when a calling operation is done, the operation control unit 12 reads the set conditions stored in the storing unit 14 in association with the workflow name, and displays the conditions on the workflow display unit 132.

The use of the function of calling a set workflow can eliminate the work of creating the same workflow again.

As process procedures that achieve the image output system according to each embodiment are recorded on a recording medium as a program, the functions provided by each embodiment of the present invention can be realized as a central processing unit (CPU) of the computer constituting the system processes information under the control of the program supplied from the recording medium.

In this case, the present invention is adaptable even to a case where pieces of information including the program are supplied to an output apparatus from the recording medium or from an external recording medium via a network.

Namely, program codes read from the recording medium achieve new functions of the present invention, and a recording medium recording the program codes, and signals read from the recording medium are constituent elements of the invention.

As the recording medium, for example, a floppy (registered trademark) disk, a hard disk, an optical disk, a magnetic optical disk, a CD-ROM, a CD-R, a magnetic tape, a nonvolatile memory card, a read only memory (ROM), and an electrically erasable programmable ROM (EEPROM) can be used.

The program according to the present invention can allow a computer that is controlled by the program to realize the function of any one of the server, the client PC, and the discovery in each embodiment of the invention, or the functions of a combination thereof.

Further effects and modifications will readily occur to those skilled in the art. Therefore, the invention in its broader aspects is not limited to the specific details and representative embodiments shown and described herein. Accordingly, various modifications can be made without departing from the spirit or scope of the general inventive concept as defined by the appended claims and their equivalents.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
a network-information managing unit that manages first information on a device included in an information processing apparatus that is connected to a network;
a device-information acquiring unit that acquires, when setting an execution device that executes a service of a workflow in which the service is defined, second information on a device that matches a setting condition from the network-information managing unit; and
an execution-device setting unit that sets the execution device in the workflow based on the second information.

2. The information processing system according to claim 1, wherein
the execution-device setting unit selects the execution device based on a predetermined priority.

3. The information processing system according to claim 1, further comprising:
a workflow executing unit that makes the execution device execute the service according to the setting condition.

4. The information processing system according to claim 3, further comprising:
an execution-result collecting unit that receives a result of executing the service.

5. The information processing system according to claim 4, wherein
the execution-result collecting unit receives, in addition to the result of executing the service, a name of the execution device and the setting condition.

6. An image processing system comprising:
a network-information managing unit that manages first information on a device included in an image processing apparatus that is connected to a network;
a device-information acquiring unit that acquires, when setting an execution device that executes a service of a workflow in which the service is defined, second information on a device that matches a setting condition from the network-information managing unit; and
an execution-device setting unit that sets the execution device in the workflow based on the second information.

7. The image processing system according to claim 6, wherein
the execution-device setting unit selects the execution device based on a predetermined priority.

8. The image processing system according to claim 6, further comprising:
a workflow executing unit that makes the execution device execute the service according to the setting condition.

9. The image processing system according to claim 8, further comprising:
an execution-result collecting unit that receives a result of executing the service.

10. The image processing system according to claim 9, wherein
the execution-result collecting unit receives, in addition to the result of executing the service, a name of the execution device and the setting condition.

11. An execution control apparatus comprising:
a device-information acquiring unit that acquires, when setting an execution device that executes a service of a workflow in which the service is defined, information on a device that matches a setting condition, from among a plurality of devices included in an image processing apparatus that is connected to a network; and
an execution-device setting unit that sets the execution device in the workflow based on the information.

12. The execution control apparatus according to claim 11, wherein
the execution-device setting unit selects the execution device based on a predetermined priority.

13. The execution control apparatus according to claim 11, further comprising:
a workflow executing unit that makes the execution device execute the service according to the setting condition.

14. The execution control apparatus according to claim 13, further comprising:
an execution-result collecting unit that receives a result of executing the service.

15. The execution control apparatus according to claim 14, wherein
the execution-result collecting unit receives, in addition to the result of executing the service, a name of the execution device and the setting condition.

16. An information processing system comprising:
a service acquiring unit that acquires a service provided by a device included in an information processing apparatus that is connected to a network;
a service display unit that displays the service in a form of a symbol; and
a workflow creating unit that creates a workflow by selecting the symbol and arranging the selected symbol on a screen.

17. The information processing system according to claim 16, further comprising:
a parameter selecting unit that selects a function for the service constituting the workflow by setting a parameter;
an execution-device retrieving unit that retrieves a device that matches the parameter set by the parameter selecting unit;
an execution-device display unit that displays the retrieved device; and
an execution-device selecting unit that selects a device that executes the service from the displayed devices.

18. The information processing system according to claim 16, wherein
when it is essential to exchange data with other service, a portion of the symbol indicating a connection with the other service is displayed with a first symbol.

19. The information processing system according to claim 18, wherein
when it is optional to exchange data with the other service, a portion indicating a connection with the other service is displayed with a second symbol that is different from the first symbol.

20. The information processing system according to claim 19, wherein
when it is impossible to exchange data with the other service, a portion indicating a connection with the other service is displayed with a third symbol that is different from the first symbol and the second symbol.

21. An execution control method comprising:
managing first information on a device included in an information processing apparatus that is connected to a network;
acquiring, when setting an execution device that executes a service of a workflow in which the service is defined, second information on a device that matches a setting condition; and
setting the execution device in the workflow based on the second information.

22. An execution control method comprising:
managing first information on a device included in an image processing apparatus that is connected to a network;
acquiring, when setting an execution device that executes a service of a workflow in which the service is defined, second information on a device that matches a setting condition; and
setting the execution device in the workflow based on the second information.

23. An execution control method comprising:
acquiring, when setting an execution device that executes a service of a workflow in which the service is defined, information on a device that matches a setting condition, from among a plurality of devices included in an image processing apparatus that is connected to a network; and
setting the execution device in the workflow based on the information.

24. A computer-readable recording medium that stores a computer program for causing a computer to execute:
managing first information on a device included in an information processing apparatus that is connected to a network;
acquiring, when setting an execution device that executes a service of a workflow in which the service is defined, second information on a device that matches a setting condition; and
setting the execution device in the workflow based on the second information.

25. A computer-readable recording medium that stores a computer program for causing a computer to execute:
managing first information on a device included in an image processing apparatus that is connected to a network;
acquiring, when setting an execution device that executes a service of a workflow in which the service is defined, second information on a device that matches a setting condition; and
setting the execution device in the workflow based on the second information.

26. A computer-readable recording medium that stores a computer program for causing a computer to execute:
acquiring, when setting an execution device that executes a service of a workflow in which the service is defined, information on a device that matches a setting condition, from among a plurality of devices included in an image processing apparatus that is connected to a network; and
setting the execution device in the workflow based on the information.
